(19) United States
(12) Patent Application Publication
(10) Pub. No.: US 2024/0292316 A1
(43) Pub. Date: Aug. 29, 2024

(54) CELL BARRING TECHNIQUES FOR DEVICES WITH NETWORK ENERGY SAVING CAPABILITIES

(71) Applicant: QUALCOMM Incorporated, San Diego, CA (US)

(72) Inventors: Naeem AKL, BRIDGEWATER, NJ (US); Navid ABEDINI, Basking Ridge, NJ (US); Shanshan WANG, San Diego, CA (US); Sherif ELAZZOUNI, San Diego, CA (US); Shankar KRISHNAN, San Diego, CA (US)

(21) Appl. No.: 18/415,488

(22) Filed: Jan. 17, 2024

Related U.S. Application Data
(60) Provisional application No. 63/487,241, filed on Feb. 27, 2023.

(51) Int. Cl. H04W 48/04; H04W 36/00; H04W 52/02

(52) U.S. Cl. CPC H04W 48/04; H04W 36/0077; H04W 52/0203

(57) ABSTRACT

Methods, systems, and devices for wireless communication are described. A user equipment (UE) may receive, via a first cell, first system information that indicates a first cell barring parameter associated with the first cell. The first cell barring parameter may indicate whether UEs are barred from accessing the first cell. The UE may receive, via a second cell, second system information that indicates a second cell barring parameter associated with the first cell. The second cell barring parameter may be applicable to UEs of a first type associated with a UE capability to communicate via cells that support one or more network energy saving (NES) procedures. The UE may participate in communications via the first cell based on the UE being of the first type and the second cell barring parameter indicating that UEs of the first type are permitted to access the first cell.

### CROSS REFERENCE

The present Application for Patent claims the benefit of U.S. Provisional Patent Application No. 63/487,241 by AKL et al., entitled “CELL BARRING TECHNIQUES FOR DEVICES WITH NETWORK ENERGY SAVING CAPABILITIES,” filed Feb. 27, 2023, assigned to the assignee hereof, and expressly incorporated by reference herein.

### FIELD OF TECHNOLOGY

The following relates to wireless communication, including cell barring techniques for devices with network energy saving (NES) capabilities.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may be configured to monitor a cell for system information. If, for example, the system information indicates that the cell is barred (e.g., unavailable), the UE may have to search for another cell, resulting in extraneous power consumption and higher processing overhead.

### SUMMARY

The described techniques relate to improved methods, systems, devices, and apparatuses that support cell barring techniques for devices with network energy saving (NES) capabilities. In accordance with aspects of the present disclosure, a user equipment (UE) may receive, via a first cell, first system information that indicates a first cell barring parameter associated with the first cell. The first cell barring parameter may be indicative of whether UEs are barred from accessing the first cell. The UE may receive, via a second cell, second system information that indicates a second cell barring parameter associated with the first cell, where the second cell barring parameter is applicable to UEs of a first type associated with a UE capability to communicate via cells that support one or more NES procedures. Accordingly, the UE may participate in communications via the first cell based on the UE being of the first type and the second cell barring parameter indicating that UEs of the first type are permitted to access the first cell. In some implementations, the first system information or the second system information may include cell reselection information pertaining to cells that support NES techniques. The first cell and the second cell may be the same cell in some situations, or they may be different cells in other scenarios.

A method for wireless communication at a UE is described. The method may include: receiving, via a first cell, first system information that indicates a first cell barring parameter associated with the first cell, where the first cell barring parameter is indicative of whether UEs are barred from accessing the first cell; receiving, via a second cell, second system information that indicates a second cell barring parameter associated with the first cell, where the second cell barring parameter is applicable to UEs of a first type, and where the first type is associated with a UE capability to communicate via cells that support one or more NES procedures; and participating in communications via the first cell based on the UE being of the first type and the second cell barring parameter indicating that UEs of the first type are permitted to access the first cell.

An apparatus for wireless communication at a UE is described. The apparatus may include a processor, memory coupled with the processor, and instructions stored in the memory. The instructions may be executable by the processor to cause the apparatus to: receive, via a first cell, first system information that indicates a first cell barring parameter associated with the first cell, where the first cell barring parameter is indicative of whether UEs are barred from accessing the first cell; receive, via a second cell, second system information that indicates a second cell barring parameter associated with the first cell, where the second cell barring parameter is applicable to UEs of a first type, and where the first type is associated with a UE capability to communicate via cells that support one or more NES procedures; and participate in communications via the first cell based on the UE being of the first type and the second cell barring parameter indicating that UEs of the first type are permitted to access the first cell.

Another apparatus for wireless communication at a UE is described. The apparatus may include: means for receiving, via a first cell, first system information that indicates a first cell barring parameter associated with the first cell, where the first cell barring parameter is indicative of whether UEs are barred from accessing the first cell; means for receiving, via a second cell, second system information that indicates a second cell barring parameter associated with the first cell, where the second cell barring parameter is applicable to UEs of a first type, and where the first type is associated with a UE capability to communicate via cells that support one or more NES procedures; and means for participating in communications via the first cell based on the UE being of the first type and the second cell barring parameter indicating that UEs of the first type are permitted to access the first cell.

A non-transitory computer-readable medium storing code for wireless communication at a UE is described. The code may include instructions executable by a processor to: receive, via a first cell, first system information that indicates a first cell barring parameter associated with the first cell, where the first cell barring parameter is indicative of whether UEs are barred from accessing the first cell; receive, via a second cell, second system information that indicates a second cell barring parameter associated with the first cell, where the second cell barring parameter is applicable to UEs of a first type, and where the first type is associated with a UE capability to communicate via cells that support one or more NES procedures; and participate in communications via the first cell based on the UE being of the first type and the second cell barring parameter indicating that UEs of the first type are permitted to access the first cell.

In some examples of the methods, apparatuses, and non-transitory computer-readable media described herein, the second cell barring parameter supersedes the first cell barring parameter for UEs of the first type.

In some examples of the methods, apparatuses, and non-transitory computer-readable media described herein, the second cell and the first cell may be the same, and the first system information and the second system information may be received in a master information block (MIB) that indicates both the first cell barring parameter and the second cell barring parameter.

In some examples of the methods, apparatuses, and non-transitory computer-readable media described herein, receiving the first system information may include operations, features, means, or instructions for receiving a MIB that indicates the first cell barring parameter.

In some examples of the methods, apparatuses, and non-transitory computer-readable media described herein, receiving the second system information may include operations, features, means, or instructions for receiving a system information block (SIB) that indicates the second cell barring parameter.

In some examples of the methods, apparatuses, and non-transitory computer-readable media described herein, the second cell barring parameter may be a flag in the SIB and presence of the flag in the SIB indicates that UEs of the first type are permitted to access the first cell.

Some examples of the methods, apparatuses, and non-transitory computer-readable media described herein may further include operations, features, means, or instructions for evaluating the presence of the flag in the SIB only when the first cell barring parameter in the MIB indicates that UEs are barred from accessing the first cell.

In some examples of the methods, apparatuses, and non-transitory computer-readable media described herein, the second cell barring parameter may be a field in the SIB and a value of the field may be indicative to UEs that are not of the first type that the first cell is not available, and indicative to UEs of the first type that the first cell is available.

In some examples of the methods, apparatuses, and non-transitory computer-readable media described herein, the field in the SIB may be one of a cell reservation field or a transmit power field.

In some examples of the methods, apparatuses, and non-transitory computer-readable media described herein, receiving the second system information may include operations, features, means, or instructions for receiving a SIB that includes the second cell barring parameter, where the SIB includes cell reselection information pertaining to cells that support one or more NES procedures, the first cell being among the cells identified in the cell reselection information.

In some examples of the methods, apparatuses, and non-transitory computer-readable media described herein, receiving the first system information may include operations, features, means, or instructions for receiving, as part of a reselection procedure where the first UE transitions from the second cell to the first cell, a MIB that indicates the first cell barring parameter, where the first cell barring parameter indicates that UEs are barred from accessing the first cell, but where the second cell barring parameter supersedes the first cell barring parameter for UEs of the first type.

In some examples of the methods, apparatuses, and non-transitory computer-readable media described herein, the second cell and the first cell may be the same. Some examples of the methods, apparatuses, and non-transitory computer-readable media may include further operations, features, means, or instructions for: receiving third system information, via a third cell that may be different from the first cell and the second cell, the third system information being received, prior to reception of the first system information and the second system information, in a SIB that identifies that the first cell supports the one or more NES procedures; and reselecting the first cell based on the third system information identifying that the first cell supports the one or more NES procedures, where reception of the first system information and the second system information occurs after or a result of the reselection.

In some examples of the methods, apparatuses, and non-transitory computer-readable media described herein, receiving the first system information may include operations, features, means, or instructions for receiving a MIB that indicates the first cell barring parameter.

In some examples of the methods, apparatuses, and non-transitory computer-readable media described herein, receiving the second system information may include operations, features, means, or instructions for receiving an additional SIB that indicates the second cell barring parameter.

In some examples of the methods, apparatuses, and non-transitory computer-readable media described herein, the first system information and the second system information may be received in a MIB that indicates both the first cell barring parameter and the second cell barring parameter.

Some examples of the methods, apparatuses, and non-transitory computer-readable media described herein may further include operations, features, means, or instructions for refraining from decoding the first system information based on the third system information.

A method for wireless communication at a UE is described. The method may include: receiving, via a first cell, system information that includes cell reselection information pertaining to cells that support one or more NES procedures; performing a cell reselection procedure based on the cell reselection information; and participating in one or more communications via a second cell based on the cell reselection procedure.

An apparatus for wireless communication at a UE is described. The apparatus may include a processor, memory coupled with the processor, and instructions stored in the memory. The instructions may be executable by the processor to cause the apparatus to: receive, via a first cell, system information that includes cell reselection information pertaining to cells that support one or more NES procedures; perform a cell reselection procedure based on the cell reselection information; and participate in one or more communications via a second cell based on the cell reselection procedure.

Another apparatus for wireless communication at a UE is described. The apparatus may include: means for receiving, via a first cell, system information that includes cell reselection information pertaining to cells that support one or more NES procedures; means for performing a cell reselection procedure based on the cell reselection information; and means for participating in one or more communications via a second cell based on the cell reselection procedure.

A non-transitory computer-readable medium storing code for wireless communication at a UE is described. The code may include instructions executable by a processor to: receive, via a first cell, system information that includes cell reselection information pertaining to cells that support one or more NES procedures; perform a cell reselection procedure based on the cell reselection information; and participate in one or more communications via a second cell based on the cell reselection procedure.

In some examples of the methods, apparatuses, and non-transitory computer-readable media described herein, receiving the system information may include operations, features, means, or instructions for receiving, via the first cell, at least one SIB that indicates a list of cells that support one or more NES procedures.

Some examples of the methods, apparatuses, and non-transitory computer-readable media described herein may further include operations, features, means, or instructions for prioritizing or de-prioritizing one or more candidate cells based on the at least one SIB and a capability of the UE to communicate with cells that support one or more NES procedures.

Some examples of the methods, apparatuses, and non-transitory computer-readable media described herein may further include operations, features, means, or instructions for: determining that the second cell supports one or more NES procedures based on the at least one SIB; and receiving a first SIB via the second cell that supports NES procedures based on performing the cell reselection procedure, where the first SIB includes a flag to indicate that UEs of a first type are permitted to access the second cell, and where the first type is associated with a UE capability to communicate with cells that support one or more NES procedures.

In some examples of the methods, apparatuses, and non-transitory computer-readable media described herein, receiving the system information may include operations, features, means, or instructions for receiving, via the first cell, at least one SIB that indicates one or both of an intra-frequency excluded cell list or an inter-frequency excluded cell list pertaining to UEs that are capable of communicating via cells that support one or more NES procedures.

In some examples of the methods, apparatuses, and non-transitory computer-readable media described herein, receiving the system information may include operations, features, means, or instructions for receiving, via the first cell, at least one SIB that indicates one or both of inter-cell reselection priority information or intra-cell reselection priority information pertaining to UEs that are capable of communicating via cells that support one or more NES procedures.

In some examples of the methods, apparatuses, and non-transitory computer-readable media described herein, receiving the system information may include operations, features, means, or instructions for receiving, via the first cell, at least one SIB that indicates a list of frequencies associated with cells that support one or more NES procedures.

Some examples of the methods, apparatuses, and non-transitory computer-readable media described herein may further include operations, features, means, or instructions for prioritizing or de-prioritizing one or more candidate frequencies based on the at least one SIB and a capability of the UE to communicate with cells that support one or more NES procedures.

In some examples of the methods, apparatuses, and non-transitory computer-readable media described herein, performing the cell reselection procedure may include operations, features, means, or instructions for selecting the second cell based on a capability of the UE to communicate with cells that support one or more NES procedures and the cell reselection information indicating that the second cell supports one or more NES procedures.

In some examples of the methods, apparatuses, and non-transitory computer-readable media described herein, receiving the system information may include operations, features, means, or instructions for receiving, via the first cell, UE assistance information that includes a list of candidate cells that support one or more NES procedures.

Some examples of the methods, apparatuses, and non-transitory computer-readable media described herein may further include operations, features, means, or instructions for refraining from processing a MIB associated with a cell that supports one or more NES procedures based on the UE assistance information.

Some examples of the methods, apparatuses, and non-transitory computer-readable media described herein may further include operations, features, means, or instructions for establishing a connection with a network entity via the first cell prior to receiving the cell reselection information via the first cell.

Some examples of the methods, apparatuses, and non-transitory computer-readable media described herein may further include operations, features, means, or instructions for establishing a connection with a network entity via the second cell after performing the cell reselection procedure in accordance with the cell reselection information.

A method for wireless communication at a network entity is described. The method may include outputting, via a first cell, first system information that pertains to a second cell and indicates a first cell barring parameter that is applicable to UEs of a first type and which supersedes a second cell barring parameter provided via a second system information, where the first type is associated with a UE capability to communicate via cells that support one or more NES procedures.

An apparatus for wireless communication at a network entity is described. The apparatus may include a processor, memory coupled with the processor, and instructions stored in the memory. The instructions may be executable by the processor to cause the apparatus to output, via a first cell, first system information that pertain to a second cell and indicates a first cell barring parameter that is applicable to UEs of a first type and which supersedes a second cell barring parameter provided via a second system information, where the first type is associated with a UE capability to communicate via cells that support one or more NES procedures.

Another apparatus for wireless communication at a network entity is described. The apparatus may include means for outputting, via a first cell, first system information that pertains to a second cell and indicates a first cell barring parameter that is applicable to UEs of a first type and which supersedes a second cell barring parameter provided via a second system information, where the first type is associated with a UE capability to communicate via cells that support one or more NES procedures.

A non-transitory computer-readable medium storing code for wireless communication at a network entity is described. The code may include instructions executable by a processor to output, via a first cell, first system information that pertain to a second cell and indicates a first cell barring parameter that is applicable to UEs of a first type and which supersedes a second cell barring parameter provided via a second system information, where the first type is associated with a UE capability to communicate via cells that support one or more NES procedures.

In some examples of the methods, apparatuses, and non-transitory computer-readable media described herein, the second cell barring parameter supersedes the first cell barring parameter for UEs of the first type.

In some examples of the methods, apparatuses, and non-transitory computer-readable media described herein, the second cell and the first cell may be the same and the first system information and the second system information may be received in a MIB that indicates both the first cell barring parameter and the second cell barring parameter.

In some examples of the methods, apparatuses, and non-transitory computer-readable media described herein, outputting the first system information may include operations, features, means, or instructions for outputting a MIB that indicates the first cell barring parameter.

Some examples of the methods, apparatuses, and non-transitory computer-readable media described herein may further include operations, features, means, or instructions for outputting a SIB that indicates the second cell barring parameter.

In some examples of the methods, apparatuses, and non-transitory computer-readable media described herein, the second cell barring parameter may be a flag in the SIB and presence of the flag in the SIB indicates that UEs of the first type are permitted to access the first cell.

In some examples of the methods, apparatuses, and non-transitory computer-readable media described herein, the second cell barring parameter may be a field in the SIB and a value of the field may be indicative to UEs that are not of the first type that the first cell is not available, and indicative to UEs of the first type that the first cell is available.

In some examples of the methods, apparatuses, and non-transitory computer-readable media described herein, the field in the SIB may be one of a cell reservation field or a transmit power field.

### BRIEF DESCRIPTION OF THE DRAWINGS

FIGS. 1 and 2 illustrate examples of wireless communications systems that support cell barring techniques for devices with network energy saving (NES) capabilities in accordance with one or more aspects of the present disclosure.

FIGS. 3A, 3B, 3C, 3D, and 3E illustrate examples of signaling diagrams that support cell barring techniques for devices with NES capabilities in accordance with one or more aspects of the present disclosure.

FIG. 4 illustrates an example of a process flow that supports cell barring techniques for devices with NES capabilities in accordance with one or more aspects of the present disclosure.

FIG. 5 illustrates an example of a process flow that supports cell barring techniques for devices with NES capabilities in accordance with one or more aspects of the present disclosure.

FIGS. 6 and 7 illustrate block diagrams of devices that support cell barring techniques for devices with NES capabilities in accordance with one or more aspects of the present disclosure.

FIG. 8 illustrates a block diagram of a communications manager that supports cell barring techniques for devices with NES capabilities in accordance with one or more aspects of the present disclosure.

FIG. 9 illustrates a diagram of a system including a device that supports cell barring techniques for devices with NES capabilities in accordance with one or more aspects of the present disclosure.

FIGS. 10 and 11 illustrate block diagrams of devices that support cell barring techniques for devices with NES capabilities in accordance with one or more aspects of the present disclosure.

FIG. 12 illustrates a block diagram of a communications manager that supports cell barring techniques for devices with NES capabilities in accordance with one or more aspects of the present disclosure.

FIG. 13 illustrates a diagram of a system including a device that supports cell barring techniques for devices with NES capabilities in accordance with one or more aspects of the present disclosure.

FIGS. 14 and 15 illustrate flowcharts showing methods that support cell barring techniques for devices with NES capabilities in accordance with one or more aspects of the present disclosure.

### DETAILED DESCRIPTION

In some wireless communications systems, a user equipment (UE) may receive system information, such as a master information block (MIB) or a system information block (SIB), by monitoring a cell. The system information may include, among other parameters, a cell barring field (e.g., cellBarred) to indicate whether the cell is available or barred (i.e., unavailable). If the cell barring field is set to False, the cell may be available to UEs. Thus, UEs may continue participating in communications via the cell, for example, by receiving other system information (OSI) and, in some cases, establishing a connection with the cell. Alternatively, if the cell barring field is set to True, the cell may be barred (e.g., unavailable) to UEs. In such instances, UEs monitoring the cell may select and/or camp on (e.g., monitor) a different cell.

Some cells may support network energy saving (NES) techniques, such as cell discontinuous reception (DRX), cell discontinuous transmission (DTX), mobility enhancements, and the like. It may be beneficial for UEs that are unable to communicate with NES-capable cells (such as legacy UEs or NES-incapable UEs) to camp on cells that do not support NES techniques or cells that are not actively using NES techniques. Likewise, it may be advantageous for NES-capable cells to selectively bar access to UEs on the basis of NES capabilities (for example, based on whether a UE is capable of communicating with cells that support NES techniques). However, NES capability information (such as whether a cell supports NES techniques) may not be readily apparent from the system information, and the cell barring field may not distinguish between NES-capable UEs and NES-incapable UEs.

Aspects of the present disclosure support techniques for enabling a cell to selectively bar access for NES-incapable UEs and permit access for NES-capable UEs (or vice versa). For example, a second cell barring field (cellBarred-NES) may be used to indicate whether cell access is barred for UEs that are capable of communicating with NES-capable cells. If this field is set to False, NES-capable UEs may connect to the cell, even if the first cell barring field (e.g., cellBarred) is set to True. As described herein, the second cell barring field may be conveyed via a MIB or a SIB (such as SIB1, SIB2, SIB3, or SIB4). In some examples, the second cell barring field is conveyed via the same MIB that conveys the first cell barring field. In other examples, the second cell barring field is conveyed via a SIB1 of the same cell whose MIB carries the first cell barring field. And in yet another example, the second cell barring field is conveyed via a SIB (e.g., SIB2, SIB3, or SIB4) of a cell that is different from the cell whose MIB carries the first cell barring field. In some examples, cell barring information for NES-capable UEs (such as whether a cell is barred for an NES-capable UE) may be signaled via a SIB1 flag, a cell reservation field, a transmission power field, or the like.

Additionally, or alternatively, a cell may be configured to transmit cell barring information and/or cell reselection information for other NES-capable cells via system information, such as SIB2-4. The cell barring information may include, for example, a list of candidate cells that support NES techniques. The cell reselection information may include an intra-frequency excluded cell list for NES-capable UEs, an inter-frequency excluded cell list for NES-capable UEs, cell reselection priority information for NES-capable UEs, and the like. NES-capable UEs may use this information for cell prioritization, selection, reselection, etc.

Aspects of the present disclosure may be implemented to realize one or more of the following advantages. The techniques described herein may support reduced power consumption, lower processing overhead, and decreased signaling overhead, among other benefits. For example, if an NES-incapable UE determines that a first cell supports NES techniques or is actively employing NES procedures (e.g., based on assistance information provided by the first cell or a second cell), the NES-incapable UE may de-prioritize the first cell or refrain from processing other system information messages from the first cell, resulting in greater power savings and reduced processing overhead. The described techniques may also enable NES-capable cells to selectively bar access to legacy and NES-incapable UEs while permitting access to NES-capable UEs, thereby providing greater signaling flexibility and granularity.

Aspects of the present disclosure are initially described in the context of wireless communications systems, signaling diagrams, and process flows. Aspects of the disclosure are further illustrated by and described with reference to apparatus diagrams, system diagrams, and flowcharts that relate to cell barring techniques for devices with NES capabilities.

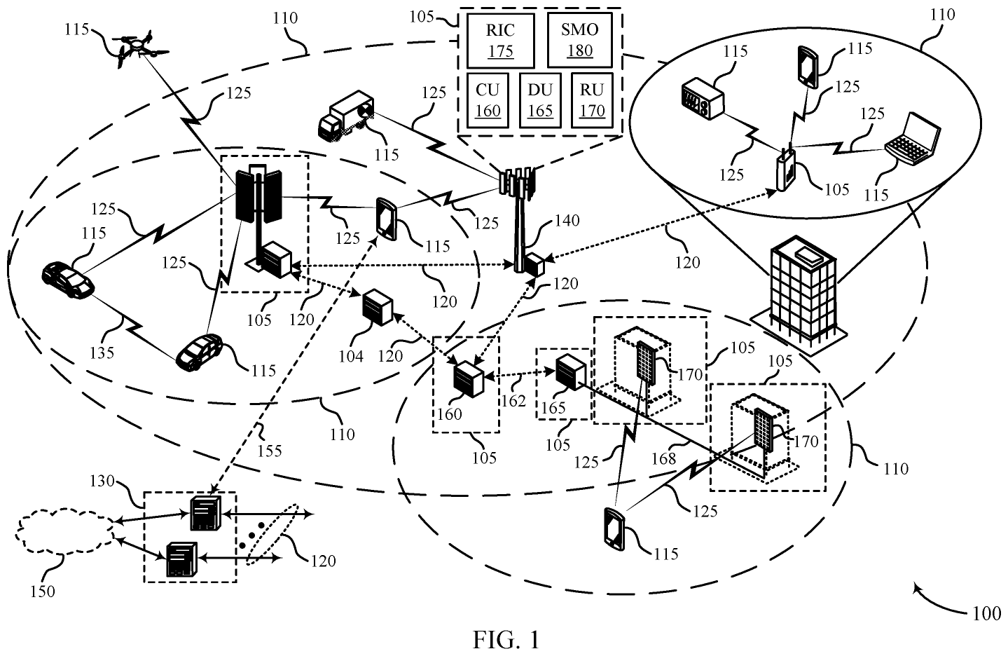

FIG. 1 illustrates an example of a wireless communications system 100 that supports cell barring techniques for devices with NES capabilities in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link) For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115.

In another aspect of this example, the first node may be a UE 115, the second node may be a network entity 105, and the third node may be a network entity 105. In yet other aspects of this example, the first, second, and third nodes may be different relative to these examples Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130).

In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof.

An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160.

Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170).

A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor.

An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support cell barring techniques for devices with NES capabilities as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling.

The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may support techniques for preventing some UEs 115 from camping on cells that use NES procedures. For some NES techniques (such as cell DTX/DRX, mobility enhancements for NES), it may be beneficial to bar legacy UEs (for example, UEs 115 that are unable to communicate with NES-capable cells) from camping on cells that are using such NES techniques. Aspects of the present disclosure support a MIB-based barring solution for NES-capable UEs, a SIB1-based barring solution for NES-capable UEs, a SIB2/3/4-based barring solution for NES-capable UEs, and various combinations thereof.

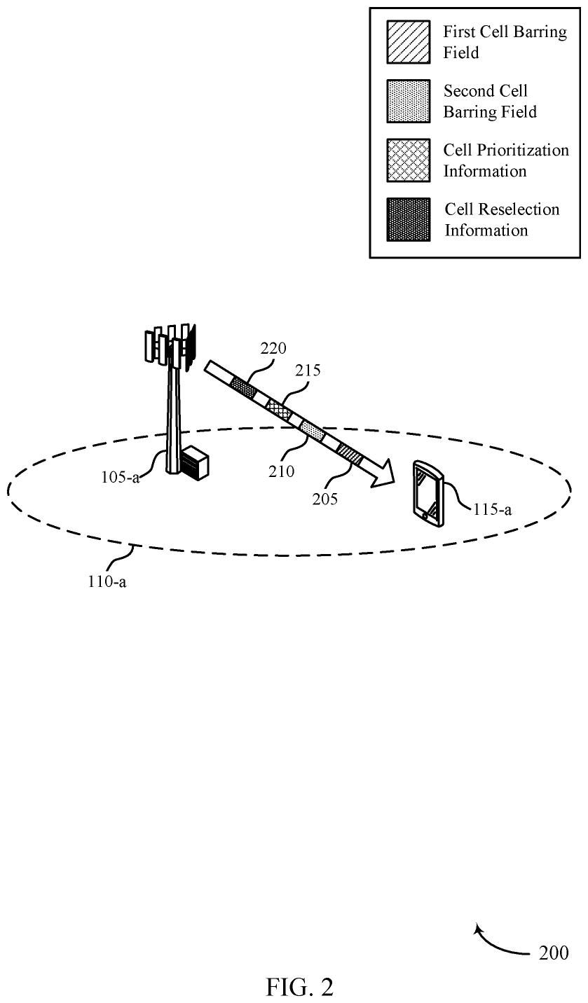

FIG. 2 illustrates an example of a wireless communications system 200 that supports cell barring techniques for devices with NES capabilities in accordance with one or more aspects of the present disclosure. The wireless communications system 200 may implement or be implemented by aspects of the wireless communications system 100. For example, the wireless communications system 200 includes a UE 115-a and a network entity 105-a, which may be examples of corresponding devices described herein, including with reference to FIG. 1. The wireless communications system 200 also includes a coverage area 110-a, which may be an example of a coverage area 110, as described with reference to FIG. 1.

In the wireless communications system 200, the UE 115-a may receive system information, such as a MIB or a SIB, by monitoring a cell associated with the network entity 105-a. The system information may include, among other parameters, a first cell barring field 205 (e.g., cellBarred) that indicates whether the cell is available or barred (i.e., unavailable). If the first cell barring field 205 is set to False, the cell may be available to the UE 115-a. As such, the UE 115-a may continue participating in communications via the cell, for example, by receiving OSI and, in some cases, establishing a connection with the network entity 105-a via the cell. Alternatively, if the first cell barring field 205 is set to True, the cell may be barred (e.g., unavailable) to the UE 115-a. In such instances, the UE 115-a may select and/or camp on (e.g., monitor) a different cell.

As described herein, some cells may support NES techniques, such as cell DRX, cell DTX, mobility enhancements, and the like. It may be beneficial for UEs that are unable to communicate with NES-capable cells (such as legacy UEs or NES-incapable UEs) to camp on cells that do not support NES techniques or cells that are not actively using NES techniques. Likewise, it may be advantageous for NES-capable cells (such as the UE 115-a) to selectively bar access to UEs on the basis of NES capabilities (for example, based on whether the UE 115-a is capable of communicating with cells that support NES techniques). However, NES capability information (such as whether a cell supports NES techniques) may not be readily apparent from the system information, and the first cell barring field 205 may not distinguish between NES-capable UEs and NES-incapable UEs.

Aspects of the present disclosure support techniques for enabling the network entity 105-a to selectively bar cell access for NES-incapable UEs and permit access for NES-capable UEs (such as the UE 115-a). For example, a second cell barring field 210 (cellBarred-NES) may be used to indicate whether cell access is barred for UEs that are capable of communicating with NES-capable cells (such as the UE 115-a). If the second cell barring field 210 is set to False, NES-capable UEs may connect to the cell, even if the first cell barring field 205 (e.g., cellBarred) is set to True. As described herein, the second cell barring field 210 may be conveyed via a MIB or a SIB (such as SIB1, SIB2, SIB3, or SIB4). In some examples, the second cell barring field is conveyed via the same MIB that conveys the first cell barring field. In other examples, the second cell barring field is conveyed via a SIB1 of the same cell whose MIB carries the first cell barring field. And in yet another example, the second cell barring field is conveyed via a SIB (e.g., SIB2, SIB3, or SIB4) of a cell that is different from the cell whose MIB carries the first cell barring field. In some examples, cell barring information for NES-capable UEs (e.g., whether a cell is barred for an NES-capable UE) may be signaled via a SIB1 flag, a cell reservation field, a transmission power field, or the like.

Additionally, or alternatively, the network entity 105-a may be configured to transmit cell prioritization information 215 and/or cell reselection information 220 for other NES-capable cells via system information, such as SIB2-4. The cell prioritization information 215 may include, for example, a list of priority rules for NES-capable UEs. The cell reselection information 220 may include a list of candidate cells that support NES techniques, an intra-frequency excluded cell list for NES-capable UEs, an inter-frequency excluded cell list for NES-capable UEs, and the like. NES-capable UEs may use this information for cell prioritization, selection, reselection, etc.

Aspects of the wireless communications system 200 may be implemented to realize one or more of the following advantages. The techniques described with reference to FIG. 2 may support reduced power consumption, lower processing overhead, and decreased signaling overhead, among other benefits. For example, if an NES-incapable UE determines that a first cell supports NES techniques or is actively employing NES procedures (e.g., based on assistance information provided by the first cell or a second cell), the NES-incapable UE may de-prioritize the first cell or refrain from processing other system information messages from the first cell, resulting in greater power savings and reduced processing overhead. The described techniques may also enable NES-capable cells to selectively bar access to legacy and NES-incapable

UEs while permitting access to NES-capable UEs (such as the UE 115-a), thereby providing greater signaling flexibility and granularity.

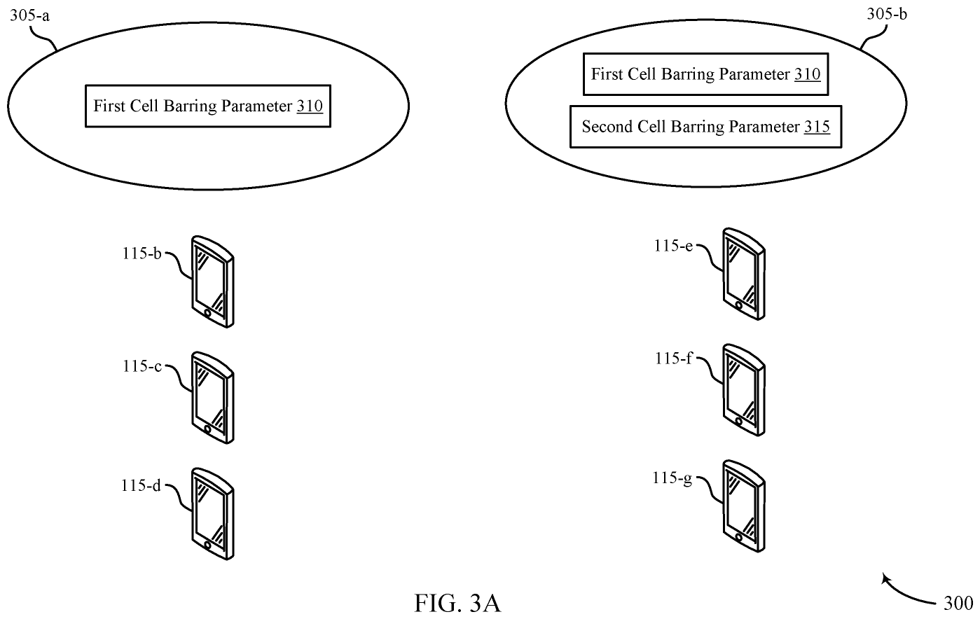

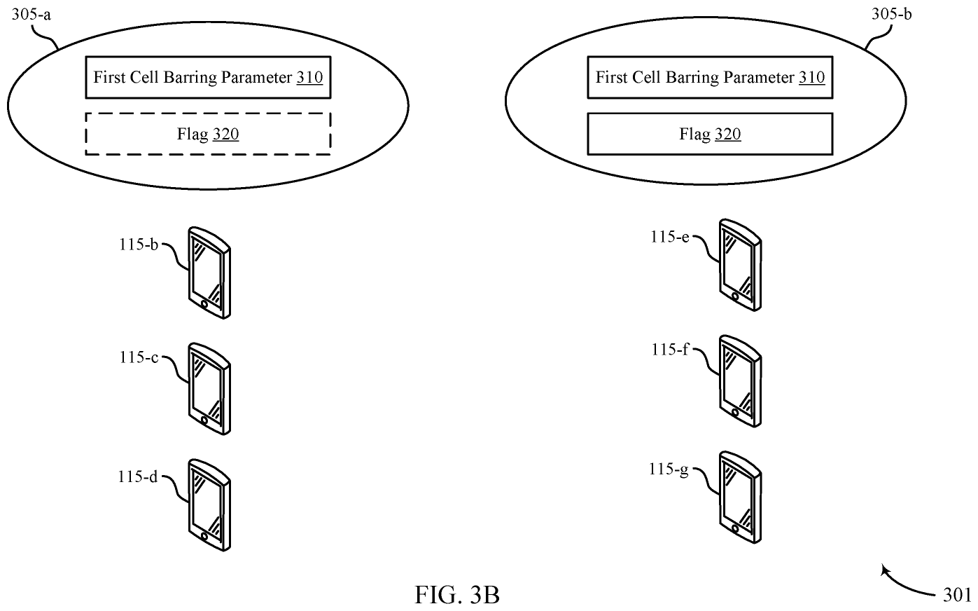

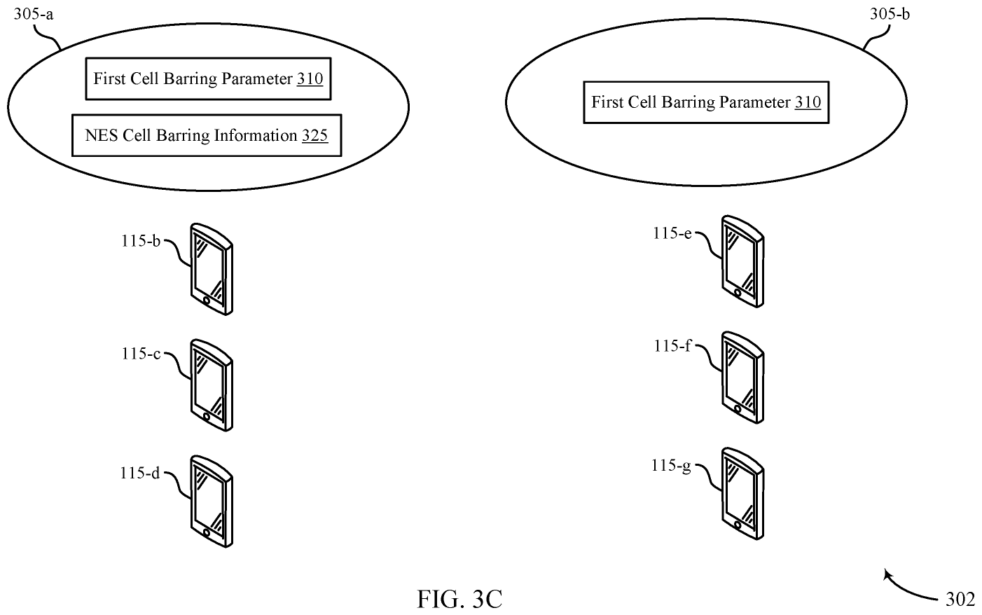

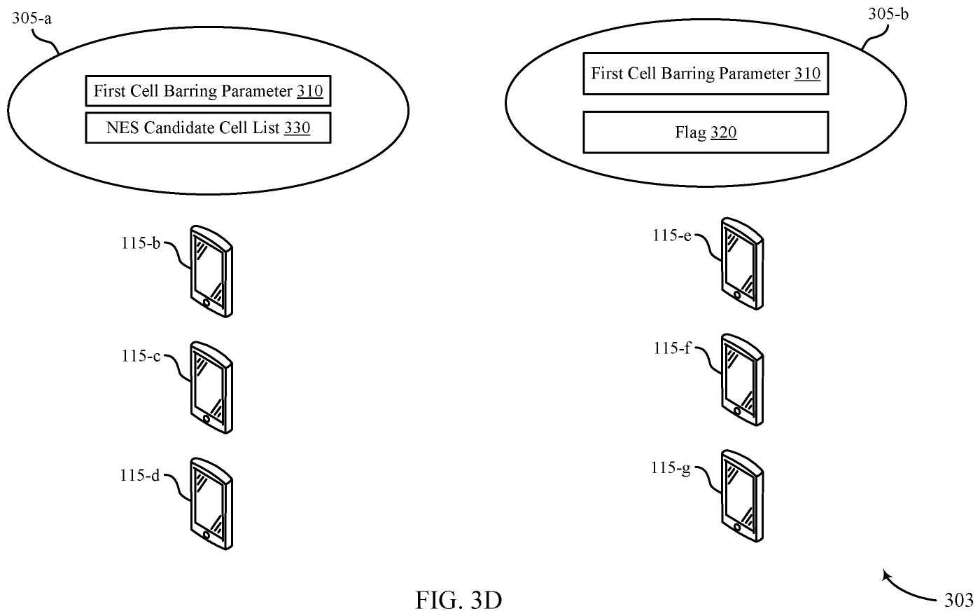

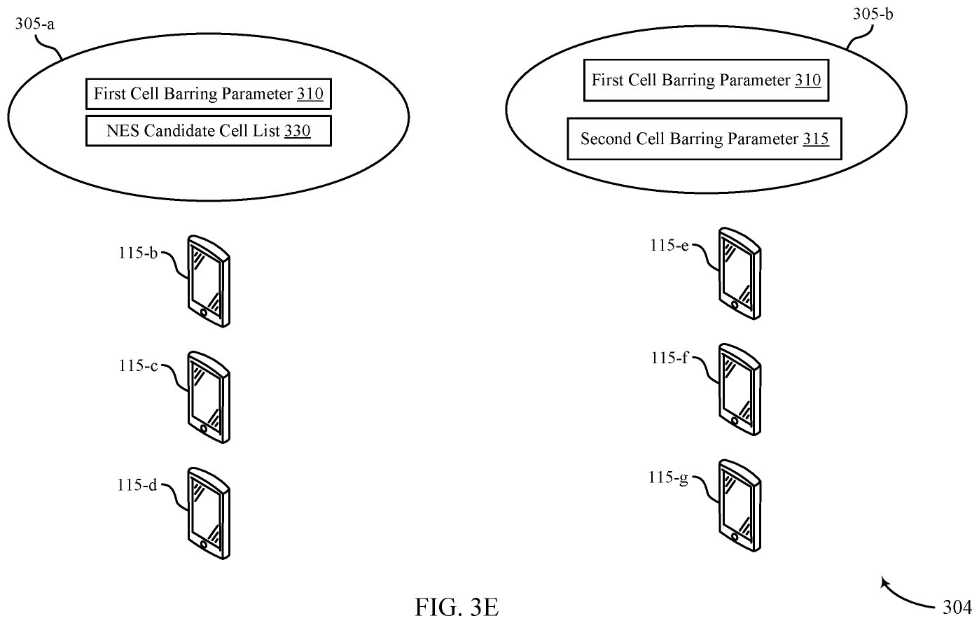

FIGS. 3A, 3B, 3C, 3D, and 3E illustrate examples of a signaling diagram 300, a signaling diagram 301, a signaling diagram 302, a signaling diagram 303, and a signaling diagram 304, respectively, that support cell barring techniques for devices with NES capabilities in accordance with one or more aspects of the present disclosure. Each of the signaling diagrams 300 through 304 may implement or be implemented by one or more aspects of the wireless communications system 100 or the wireless communications system 200. For example, the signaling diagrams 300 through 304 include a UE 115-b (e.g., a first legacy UE), a UE 115-c (e.g., a first NES-incapable UE), a UE 115-d (e.g., a first NES-capable UE), a UE 115-e (e.g., a second legacy UE), a UE 115-f (e.g., a second NES-incapable UE), and a UE 115-g (e.g., a second NES-capable UE), which may be examples of a UE 115 described herein, including with reference to FIGS. 1 and 2. The signaling diagrams 300 through 304 also include a cell 305-a (referred to herein as cell 1) and a cell 305-b (referred to herein as cell 2), which may be examples of other cells described herein, including with reference to FIGS. 1 and 2.

In the example of FIG. 3A, a first set of UEs 115 (e.g., the UE 115-b, the UE 115-c, and the UE 115-d) may receive, via the cell 305-a, a MIB that indicates a first cell barring parameter 310 (e.g., cellBarred). Likewise, a second set of UEs 115 (e.g., the UE 115-e, the UE 115-f, and the UE 115-g) may receive, via the cell 305-b, a MIB that indicates the first cell barring parameter 310 and a second cell barring parameter 315 (e.g., cellBarred-NES). The second cell barring parameter 315 (which may be an example of the second cell barring field 210 described with reference to FIG. 2) may be used to indicate barring information for NES-capable UEs, such as the UE 115-g. NES-capable UEs may assume the cell 305-b is accessible if the second barring parameter 315 indicates that the cell is not barred (e.g., if cellBarred-NES =False), even if the first cell barring parameter 310 indicates otherwise (e.g., even if cellBarred=True).

In the example of FIG. 3B, the first set of UEs 115 may receive, via the cell 305-a, a MIB indicating the first cell barring parameter 310 (which may be an example of the first cell barring field 205 described with reference to FIG. 2) and SIB1. Likewise, the second set of UEs 115 may receive, via the cell 305-b, a MIB indicating the first cell barring parameter 310 and a SIB1 that includes a flag 320. In some examples, the first cell barring parameter 310 (e.g., cellBarred) may be set to False for the cell 305-a and True for the cell 305-b. The flag 320 may be absent from the SIB1 associated with the cell 305-a. In some implementations, NES-capable UEs (such as the UE 115-g) can discard (i.e., ignore) the first cell barring parameter 310 in the MIB associated with the cell 305-b. Instead, NES-capable UEs may check for the flag 320 in SIB1. If the flag 320 is present, NES-capable UEs may assume the cell 305-b is accessible. If the flag 320 is absent or muted (such as for the cell 305-a), NES-capable UEs (such as the UE 115-d) may assume the cell 305-a is barred. In some examples, NES-capable UEs may only check for the presence of the flag 320 if the first cell barring parameter 310 (e.g., cellBarred) is set to True.

In some examples, rather than using the flag 320 to convey barring information for NES-capable UEs, the SIB1 associated with the cell 305-b may indicate that legacy UEs (such as the UE 115-e) are barred from accessing the cell 305-b using a cell reservation field (e.g., cellReservation) or a transmit power field (NR-NS-PmaxList). Legacy UEs (such as the UE 115-e) may determine that the cell is unavailable by reading these SIB1 fields (cellReservation, NR-NS-PmaxList). NES-capable UEs (such as the UE 115-g) can bypass these SIB1 fields, for example, by having valid access identifiers for the cellReservation field. In some implementations, legacy UEs may receive and decode SIB1 before determining whether to access the cells 305.

In the example of FIG. 3C, the first set of UEs 115 may receive, via the cell 305-a, a MIB indicating the first cell barring parameter 310 (e.g., cellBarred) and SIB2-4 indicating NES cell barring information 325 that pertains to the cell 305-b. The second set of UEs 115 may receive, via the cell 305-b, a MIB indicating the first cell barring parameter 310. In some examples, the first cell barring parameter 310 may be set to False for the cell 305-a and True for the cell 305-b. NES-capable UEs (such as the UE 115-d) may use the NES cell barring information 325 for cell reselection. In some implementations, NES-capable UEs may be configured to select the cell 305-a first. Thereafter, the NES-capable UEs may check SIB2-4 of the cell 305-a to determine whether the cell 305-b is barred. If the cell 305-b is accessible (e.g., not barred), the NES-capable UEs may reselect the cell 305-b following an idle/inactive cell reselection procedure.

In some implementations, the cell 305-a may be an example of a macro cell that serves many UEs 115. If the cell 305-b changes the barring status for NES-capable UEs, SIB2-4 of the cell 305-a may be updated, which may affect all UEs 115 camping on the cell 305-a. If, for example, the UE 115-g (an NES-capable UE) camps on the cell 305-b after reading SIB2-4 of the cell 305-a and determines that the cell 305-b is available (e.g., not barred) for NES-capable UEs, the UE 115-g may acquire SIB2-4 of the cell 305-a (after reselecting the cell 305-b) to determine if the cell 305-b is still accessible. Otherwise, the UE 115-g may attempt to access the cell 305-b, which could result in communication failure, as the UE 115-g may be unable to receive paging messages via the cell 305-b while the cell 305-b is barred. If the cell 305-b is barred for NES-capable UEs, the techniques described with reference to FIG. 3C may save UE power in comparison to other approaches. If the cell 305-b is accessible (i.e., not barred), UEs 115 may acquire MIB and SIB1-4 of the cell 305-a, reselect the cell 305-b, and acquire MIB and SIB1 of the cell 305-b.

In the example of FIG. 3D, the first set of UEs 115 may receive, via the cell 305-a, a MIB indicating the first cell barring parameter 310 (e.g., cellBarred), a SIB1, and SIB2-4 indicating an NES candidate cell list 330 (e.g., a list of candidate cells for NES). In some examples, the NES candidate cell list 330 may include the cell 305-b. The NES candidate cell list 330 may be an example of UE assistance information that enables NES-capable UEs (such as the UE 115-d) to refrain from reading and/or decoding SIB1 from other candidate cells (such as the cell 305-b). SIB1 of the cell 305-a may include a flag 320 to indicate barring information for NES-capable UEs. For legacy and NES-incapable UEs (such as the UE 115-e and the UE 115-f), MIB of the cell 305-b may indicate that the cell 305-b is barred. IE(s) in SIB2-4 of the cell 305-a may be discarded or ignored by these UEs. In some examples, if the cell 305-b is an NES-capable cell, legacy and non-NES-capable UEs may be unable to select or reselect the cell 305-b.

NES-capable UEs (such as the UE 115-g and the UE 115-d) may be able to determine whether the cell 305-b is accessible by directly reading SIB1 of the cell 305-b or by acquiring SIB2-4 of the cell 305-a. For example, the UE 115-d (an NES-capable UE) may camp on the cell 305-a if the first cell barring parameter 310 is set to False. After acquiring SIB2-4 of the cell 305-a, the UE 115-d may acquire information pertaining to candidate NES cells (such as the cell 305-b). Thereafter, the UE 115-d may check the SIB1 of the cell 305-b (assuming the first cell barring parameter 310 is set to True for the cell 305-b) to determine whether the cell 305-b is barred or not.

Some UEs (regardless of NES capability) may use the NES candidate cell list 330 indicated by SIB2-4 of the cell 305-a to deprioritize reselection of the cell 305-b, or to avoid reading MIB of the cell 305-b. The SIB2-4 of the cell 305-a may indicate NES frequencies (intra/inter) in addition to or as an alternative to listing NES candidate cells. As such, the UEs 115 can prioritize candidate frequencies and/or perform cell (re)selection based on whether the UEs 115 are capable of communicating with NES-capable cells.

Additionally, or alternatively, SIB3 or SIB4 of the cells 305 may be modified to include cell reselection information (such as the cell reselection information 220 described with reference to FIG. 2) and NES cell prioritization information, such as IntraFreqExcludedCellList or InterFreqExcludedCellList. The NES cell prioritization information may be applicable to all UEs 115, and may indicate an excluded list of cells for NES. The excluded cell list(s) can be used to inform UEs 115 of whether to consider NES-cells for cell (re)selection. A new IntraFreqExcludedCellList-NES IE or a new InterFreqExcludedCellList-NES may be added to SIB3/SIB4, respectively. If these fields are present, NES-capable UEs can ignore/disregard the IntraFreqExcludedCellList and InterFreqExcludedCellList fields, and use the NES-specific fields to acquire information on excluded cells for NES-capable UEs.

Similarly, SIB2/SIB4 may be modified to include a cellReselectionPriority field for inter/intra-frequency cell reselection, respectively. It may be desirable to use different priority rules for NES-capable UEs during cell reselection. For example, the network may want to route NES-capable UEs to or away from NES-capable cells. A new cellReselectionPriority-NES field may be added to SIB2/SIB4, and may configure cell reselection for NES-capable UEs with different priorities. NES-capable UEs can ignore or discard the cellReselectionPriority field in SIB2/SIB4 when the cellReselectionPriority-NES field is present.

In the example of FIG. 3E, the first set of UEs 115 may receive, via the cell 305-a, a MIB indicating the first cell barring parameter 310, a SIB1, and SIB2-4 indicating the NES candidate cell list 330. As described herein, the NES candidate cell list 330 may be an example of UE assistance information that enables NES-capable UEs (such as the UE 115-d and the UE 115-g) to avoid reading SIB1 of candidate NES cells (such as the cell 305-b). The second set of UEs 115 may receive, via the cell 305-b, a MIB indicating the first cell barring parameter 310 and the second cell barring parameter 315. In some examples, the first cell barring parameter 310 may be set to False for the cell 305-a and True for the cell 305-b. The second cell barring parameter 315 may be set to False for the cell 305-b, indicating that NES-capable UEs (such as the UE 115-g) are permitted to camp on or otherwise access the cell 305-b.

The techniques described with reference to FIG. 3E may incorporate aspects of other approaches described with reference to FIGS. 3A-3D, and may enable some UEs to skip MIB processing for cells that support NES techniques (such as the cell 305-b). Although aspects of the present disclosure are described in the context of MIB/SIB1 of the cell 305-b and SIB2-4 of the cell 305-a, it is to be understood that the techniques described herein are also applicable to other forms of system information (such as new or legacy SIB formats) that convey similar information.

For cell barring in IAB deployments, an IAB node may be configured to discard or ignore legacy MIB cell barring fields. Instead, an IAB-MT may check whether an IAB-support flag is present in SIB1. If so, the cell may be accessible. Otherwise, the cell may be barred. In some examples, additional system information fields (cellbarred-Redcap1Rx, cellbarred-Redcap2Rx) can be used to indicate cell barring information for reduced capability (RedCap) UEs. RedCap UEs may be configured to process the cell barring flag in MIB. The additional RedCap-specific barring parameters in SIB1 can be used when a cell is not barred for legacy UEs, but the network would like to selectively allow or disallow cell access for 1Rx and 2Rx RedCap UEs.

Similarly, another system information field/parameter (cellBarred-NTN) can be used to convey cell barring information for non-terrestrial network (NTN) devices. When connecting to an NTN, devices can ignore or discard the cellBarred field in MIB. Instead, NTN UEs can read the cellBarred-NTN field in SIB1. If the cellBarred-NTN field is set to “barred”, the cell may be barred for NTN connectivity purposes. Alternatively, if the cellBarred-NTN field is set to “notBarred”, the cell may be used (e.g., available) for NTN connectivity purposes. If the cellBarred-NTN field is absent, the UE may determine that the cell is barred for NTN connectivity purposes. The cellBarred-NTN field may only be applicable to NTN-capable UEs.

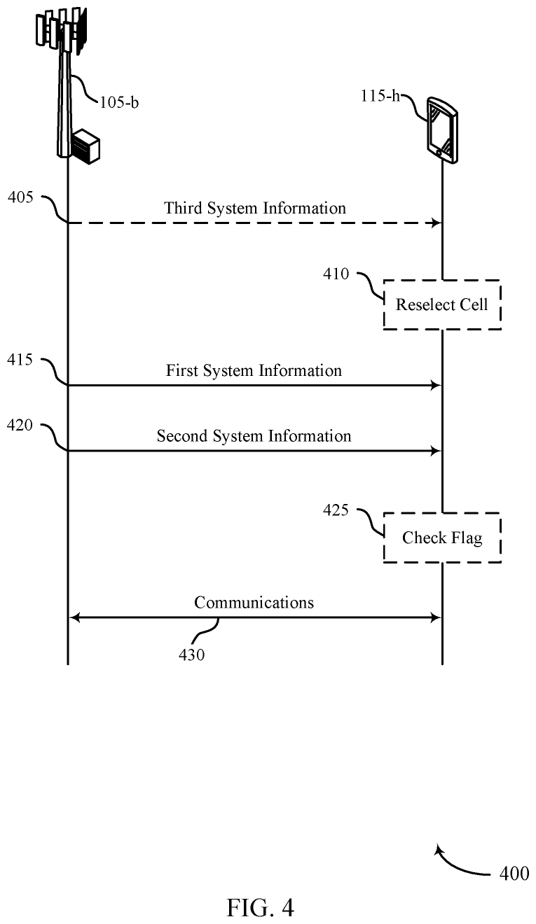

FIG. 4 illustrates an example of a process flow 400 that supports cell barring techniques for devices with NES capabilities in accordance with one or more aspects of the present disclosure. The process flow 400 may implement or be implemented by aspects of any of the wireless communications systems or signaling diagrams described with reference to FIGS. 1 through 3E. For example, the process flow 400 includes a UE 115-h and a network entity 105-b, which may be examples of corresponding devices described herein, including with reference to FIGS. 1 through 3E. In the following description of the process flow 400, operations between the UE 115-h and the network entity 105-b may be added, omitted, or performed in a different order (with respect to the exemplary order shown).

At 415, the UE 115-h may receive, via a first cell, first system information that indicates a first cell barring parameter associated with the first cell (such as the first cell barring parameter 310 described with reference to FIG. 3A). The first cell barring parameter may indicate whether UEs are barred from accessing the first cell. In some examples, the first system information may include a MIB associated with the first cell.

At 420, the UE 115-h may receive, via a second cell, second system information that indicates a second cell barring parameter associated with the first cell (such as the second cell barring parameter 315 described with reference to FIG. 3A). In some examples, the second cell is the same as the first cell. In other examples, the second cell and the first cell are different. The second cell barring parameter may be applicable to UEs of a first type, where the first type is associated with a UE capability to communicate via cells that support one or more NES procedures. The second cell barring parameter may supersede the first cell barring parameter for UEs of the first type. In some examples, both the first cell barring parameter and the second cell barring parameter may be indicated by a MIB in a cell. In other examples, the second cell barring parameter may be indicated by SIB1 in the same cell in which the MIB indicates the first cell barring parameter. In still other examples, the second cell barring parameter may be indicated by one of SIB2, SIB3, or SIB4, in a cell that is different from the one in which the first cell barring parameter is indicated.

In some implementations, the second cell barring parameter may be a flag in SIB1, and presence of the flag in SIB1 may indicate that UEs of the first type are permitted to access the first cell. At 425, the UE 115-h may evaluate the presence of the flag in SIB1 if the first cell barring parameter (in MIB) indicates that UEs are barred from accessing the first cell. In other examples, the second cell barring parameter may be a field in SIB1 (such as a cell reservation field or a transmit power field), and a value of the field may indicate, to UEs that are not of the first type (such as legacy UEs or NES-incapable UEs), that the first cell is barred, and that the first cell is available to UEs of the first type.

The second system information may optionally include cell reselection information (such as the cell reselection information 220 described with reference to FIG. 2) or cell prioritization information (such as the NES candidate cell list 330 described with reference to FIG. 3D) pertaining to cells that support one or more NES procedures. In some examples, the first cell may be among the cells identified in the cell reselection information. The cell prioritization information may include, for example, an intra-frequency excluded cell list or an inter-frequency excluded cell list pertaining to UEs that are capable of communicating via cells that support one or more NES procedures.

At 430, the UE 115-h may participate in communications with the network entity 105-b via the first cell based on the UE 115-h being of the first type and the second cell barring parameter indicating that UEs of the first type are permitted to access the first cell. In some examples, the UE 115-h may participate in communications with the network entity 105-b by establishing a connection with the network entity 105-b via the first cell.

In some implementations, the UE 115-h may receive third system information at 405 (e.g., prior to reception of the first system information and the second system information). The UE 115-h may receive the third system information via a third cell, which may be different from the first cell and the same or different from the second cell. Although the first system information, the second system information, and the third system information are depicted as being transmitted by the same device (e.g., the network entity 105-b), it is to be understood that, in some implementations, UE 115-h may receive this information from different devices. That is, the first, second, and third cell may correspond to the same entity, co-located devices, separate entities, etc. In some examples, the first cell may be the same as the second cell.

If, for example, the third system information indicates that the first cell supports one or more NES procedures and the UE 115-h is an NES-capable UE (e.g., a UE that is capable of communicating with cells that support NES techniques), the UE 115-h may reselect the first cell at 410. Alternatively, if the UE 115-h determines not to reselect the first cell, the UE 115-h may refrain from reading system information associated with the first cell, thereby promoting greater power savings and lower processing overhead.

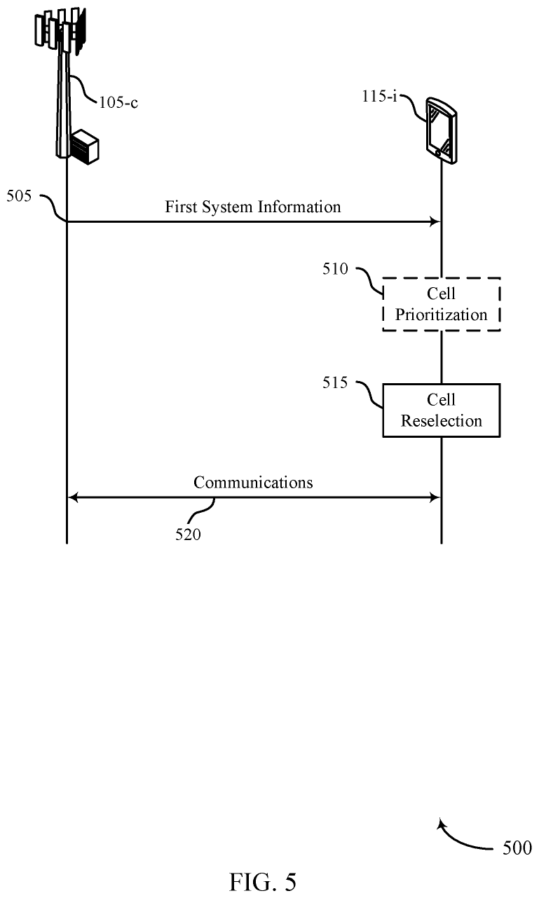

FIG. 5 illustrates an example of a process flow 500 that supports cell barring techniques for devices with NES capabilities in accordance with one or more aspects of the present disclosure. The process flow 500 may implement or be implemented by aspects of any of the wireless communications systems or signaling diagrams described with reference to FIGS. 1 through 3E. For example, the process flow 500 includes a UE 115-f and a network entity 105-c, which may be examples of corresponding devices described herein, including with reference to FIGS. 1 through 3E. In the following description of the process flow 500, operations between the UE 115-f and the network entity 105-c may be added, omitted, or performed in a different order (with respect to the exemplary order shown).

At 505, the UE 115-i may receive, via a first cell, system information that includes cell reselection information (such as the cell reselection information 220 described with reference to FIG. 2) pertaining to cells that support one or more NES procedures. The system information may also indicate cell prioritization information (such as the cell prioritization information 215 described with reference to FIG. 2) for NES-capable UEs, such as the UE 115-i. The cell reselection information and/or the cell prioritization information may be conveyed via MIB, SIB1, SIB2, SIB3, SIB4, etc. In some examples, the cell reselection information and cell prioritization information may indicated by the same message. In other examples, the cell reselection information and the cell prioritization information may be provided separately.

As described herein, the cell reselection information may include an intra-frequency excluded cell list or an inter-frequency excluded cell list pertaining to NES-capable UEs (for example, UEs that are capable of communicating via cells that support one or more NES procedures), and the cell prioritization information may include inter-frequency cell reselection priority information or intra-frequency cell reselection priority information pertaining to NES-capable UEs. In some examples, at 510, the UE 115-i may prioritize or de-prioritize one or more candidate cells based on the cell prioritization information provided via at least one SIB and a capability of the UE 115-i to communicate with cells that support NES techniques.

At 515, the UE 115-i may perform a cell reselection procedure based on the cell reselection information and/or cell prioritization information provided at 505. As a result of the cell reselection procedure, the UE 115-i may camp on (i.e., monitor) or establish a connection with a second cell, which may be the same or different from the first cell. In some examples, the UE 115-i may determine that the second cell supports NES techniques based on cell selection information indicated by at least one SIB associated with the first cell. Accordingly, the UE 115-i may receive a SIB1 via the second cell based on performing the cell reselection procedure, where the SIB1 includes a flag to indicate that NES-capable UEs (e.g., UEs of a first type) are permitted to access the second cell.

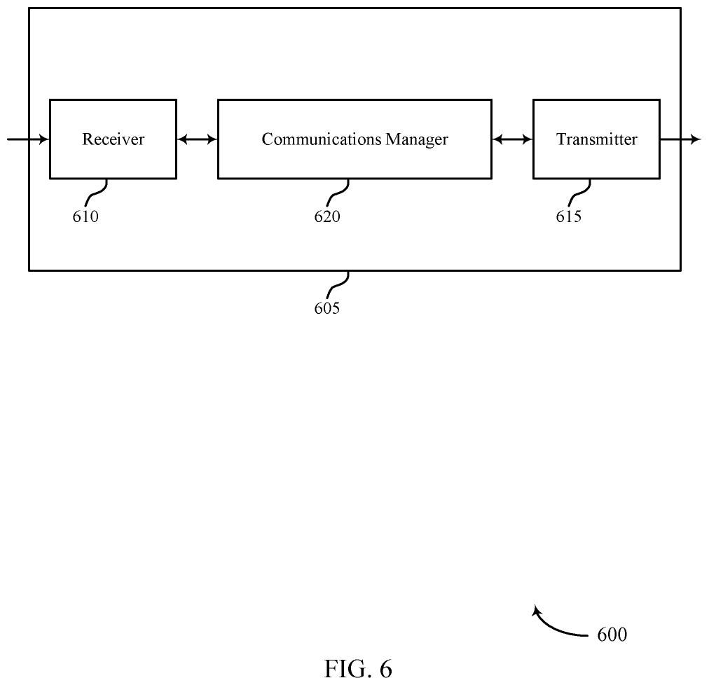

At 520, the UE 115-i may participate in communications with the network entity 105-c via a second cell based on the cell reselection procedure. In some examples, participating in the communications via the second cell may involve establishing a connection with the network entity 105-c. In some examples, the UE 115-i may refrain from decoding/processing a MIB associated with the second cell based on UE assistance information provided via the first cell. The techniques described with reference to FIG. 6 may promote greater processing efficiency, reduced signaling overhead, and greater power savings, among other benefits. Although the communications with the first cell and the second cell are indicated in FIG. 5 as being with a same device (e.g., the network entity 105-c), it is to be understood that, in some implementations, the first cell and the second cell may be associated with different network entities. That is, the first and second cells may correspond to the same entity, co-located devices, separate entities, etc.

FIG. 6 illustrates a block diagram 600 of a device 605 that supports cell barring techniques for devices with NES capabilities in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to cell barring techniques for devices with NES capabilities). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to cell barring techniques for devices with NES capabilities). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of cell barring techniques for devices with NES capabilities as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples disclosed herein. For example, the communications manager 620 may be configured as or otherwise support a means for receiving, via a first cell, first system information that indicates a first cell barring parameter associated with the first cell, where the first cell barring parameter is indicative of whether UEs are barred from accessing the first cell. The communications manager 620 may be configured as or otherwise support a means for receiving, via a second cell, second system information that indicates a second cell barring parameter associated with the first cell, where the second cell barring parameter is applicable to UEs of a first type, and where the first type is associated with a UE capability to communicate via cells that support one or more NES procedures. The communications manager 620 may be configured as or otherwise support a means for participating in communications via the first cell based on the UE being of the first type and the second cell barring parameter indicating that UEs of the first type are permitted to access the first cell.

Additionally, or alternatively, the communications manager 620 may support wireless communication at a UE in accordance with examples disclosed herein. For example, the communications manager 620 may be configured as or otherwise support a means for receiving, via a first cell, system information that includes cell reselection information pertaining to cells that support one or more NES procedures. The communications manager 620 may be configured as or otherwise support a means for performing a cell reselection procedure based on the cell reselection information. The communications manager 620 may be configured as or otherwise support a means for participating in one or more communications via a second cell based on the cell reselection procedure.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, and more efficient utilization of communication resources, among other examples.

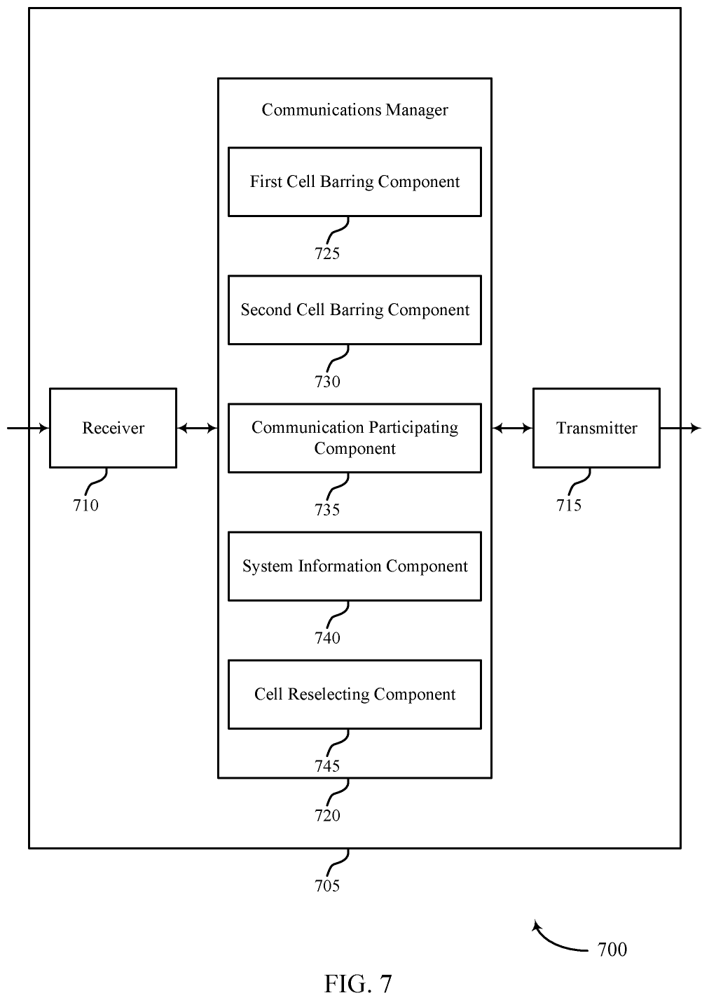

FIG. 7 illustrates a block diagram 700 of a device 705 that supports cell barring techniques for devices with NES capabilities in accordance with one or more aspects of the present disclosure. The device 705 may be an example of aspects of a device 605 or a UE 115, as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to cell barring techniques for devices with NES capabilities). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to cell barring techniques for devices with NES capabilities). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of cell barring techniques for devices with NES capabilities as described herein. For example, the communications manager 720 may include a first cell barring component 725, a second cell barring component 730, a communication participating component 735, a system information component 740, a cell reselecting component 745, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples disclosed herein. The first cell barring component 725 may be configured as or otherwise support a means for receiving, via a first cell, first system information that indicates a first cell barring parameter associated with the first cell, where the first cell barring parameter is indicative of whether UEs are barred from accessing the first cell. The second cell barring component 730 may be configured as or otherwise support a means for receiving, via a second cell, second system information that indicates a second cell barring parameter associated with the first cell, where the second cell barring parameter is applicable to UEs of a first type, and where the first type is associated with a UE capability to communicate via cells that support one or more NES procedures. The communication participating component 735 may be configured as or otherwise support a means for participating in communications via the first cell based on the UE being of the first type and the second cell barring parameter indicating that UEs of the first type are permitted to access the first cell.

Additionally, or alternatively, the communications manager 720 may support wireless communication at a UE in accordance with examples disclosed herein. The system information component 740 may be configured as or otherwise support a means for receiving, via a first cell, system information that includes cell reselection information pertaining to cells that support one or more NES procedures. The cell reselecting component 745 may be configured as or otherwise support a means for performing a cell reselection procedure based on the cell reselection information. The communication participating component 735 may be configured as or otherwise support a means for participating in one or more communications via a second cell based on the cell reselection procedure.

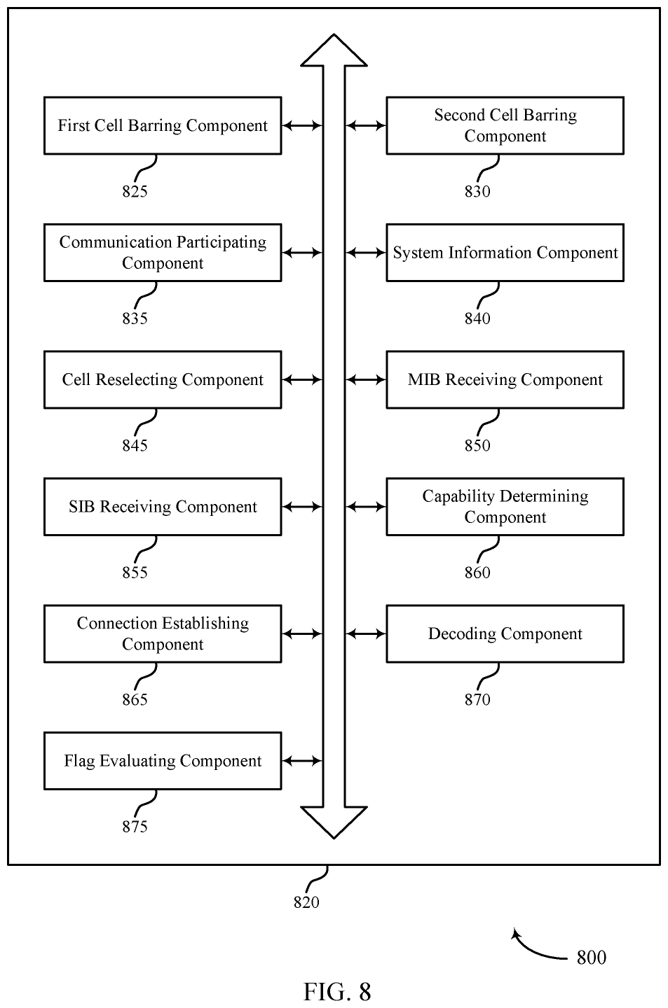

FIG. 8 illustrates a block diagram 800 of a communications manager 820 that supports cell barring techniques for devices with NES capabilities in accordance with one or more aspects of the present disclosure. The communications manager 820 may be an example of aspects of a communications manager 620, a communications manager 720, or both, as described herein. The communications manager 820, or various components thereof, may be an example of means for performing various aspects of cell barring techniques for devices with NES capabilities as described herein. For example, the communications manager 820 may include a first cell barring component 825, a second cell barring component 830, a communication participating component 835, a system information component 840, a cell reselecting component 845, a MIB receiving component 850, a SIB receiving component 855, a capability determining component 860, a connection establishing component 865, a decoding component 870, a flag evaluating component 875, or any combination thereof. Each of these components may communicate, directly or indirectly, with one another (e.g., via one or more buses).

The communications manager 820 may support wireless communication at a UE in accordance with examples disclosed herein. The first cell barring component 825 may be configured as or otherwise support a means for receiving, via a first cell, first system information that indicates a first cell barring parameter associated with the first cell, where the first cell barring parameter is indicative of whether UEs are barred from accessing the first cell. The second cell barring component 830 may be configured as or otherwise support a means for receiving, via a second cell, second system information that indicates a second cell barring parameter associated with the first cell, where the second cell barring parameter is applicable to UEs of a first type, and where the first type is associated with a UE capability to communicate via cells that support one or more NES procedures. The communication participating component 835 may be configured as or otherwise support a means for participating in communications via the first cell based on the UE being of the first type and the second cell barring parameter indicating that UEs of the first type are permitted to access the first cell.

In some examples, the second cell barring parameter supersedes the first cell barring parameter for UEs of the first type. In some examples, the second cell and the first cell are the same. In some examples, the first system information and the second system information are received in a MIB that indicates both the first cell barring parameter and the second cell barring parameter.

In some examples, to support receiving the first system information, the MIB receiving component 850 may be configured as or otherwise support a means for receiving a MIB that indicates the first cell barring parameter. In some examples, to receive the second system information, the SIB receiving component 855 may be configured as or otherwise support a means for receiving a SIB that indicates the second cell barring parameter.

In some examples, the second cell barring parameter is a flag in the SIB. In some examples, presence of the flag in the SIB indicates that UEs of the first type are permitted to access the first cell.

In some examples, the flag evaluating component 875 may be configured as or otherwise support a means for evaluating the presence of the flag in the SIB only when the first cell barring parameter in the MIB indicates that UEs are barred from accessing the first cell.

In some examples, the second cell barring parameter is a field in the SIB. In some examples, a value of the field is indicative to UEs that are not of the first type that the first cell is not available, and indicative to UEs of the first type that the first cell is available. In some examples, the field in the SIB is one of a cell reservation field or a transmit power field.

In some examples, to support receiving the second system information, the SIB receiving component 855 may be configured as or otherwise support a means for receiving a SIB that includes the second cell barring parameter, where the SIB includes cell reselection information pertaining to cells that support one or more NES procedures, the first cell being among the cells identified in the cell reselection information.

In some examples, to support receiving the first system information, the MIB receiving component 850 may be configured as or otherwise support a means for receiving, as part of a reselection procedure where the first UE transitions from the second cell to the first cell, a MIB that indicates the first cell barring parameter, where the first cell barring parameter indicates that UEs are barred from accessing the first cell, but where the second cell barring parameter supersedes the first cell barring parameter for UEs of the first type.

In some examples, the second cell and the first cell are the same, and the SIB receiving component 855 may be configured as or otherwise support a means for receiving third system information, via a third cell that is different from the first cell and the second cell, the third system information being received, prior to reception of the first system information and the second system information, in a SIB that identifies that the first cell supports the one or more NES procedures.

In some examples, the second cell and the first cell are the same, and the cell reselecting component 845 may be configured as or otherwise support a means for reselecting the first cell based on the third system information identifying that the first cell supports the one or more NES procedures, where reception of the first system information and the second system information is after or a result of the reselection.

In some examples, to support receiving the first system information, the MIB receiving component 850 may be configured as or otherwise support a means for receiving a MIB that indicates the first cell barring parameter. In some examples, to receive the second system information, the SIB receiving component 855 may be configured as or otherwise support a means for receiving an additional SIB that indicates the second cell barring parameter.

In some examples, the first system information and the second system information are received in a MIB that indicates both the first cell barring parameter and the second cell barring parameter.

In some examples, the SIB receiving component 855 may be configured as or otherwise support a means for receiving third system information, via a third cell that is different from the first cell and the second cell, the third system information being received, prior to reception of the first system information and the second system information, in a SIB that identifies that the first cell supports the one or more NES procedures.

In some examples, the decoding component 870 may be configured as or otherwise support a means for refraining from reselecting the first cell or decoding the first system information based on the third system information.

Additionally, or alternatively, the communications manager 820 may support wireless communication at a UE in accordance with examples disclosed herein. The system information component 840 may be configured as or otherwise support a means for receiving, via a first cell, system information that includes cell reselection information pertaining to cells that support one or more NES procedures. The cell reselecting component 845 may be configured as or otherwise support a means for performing a cell reselection procedure based on the cell reselection information. In some examples, the communication participating component 835 may be configured as or otherwise support a means for participating in one or more communications via a second cell based on the cell reselection procedure.

In some examples, to support receiving the system information, the SIB receiving component 855 may be configured as or otherwise support a means for receiving, via the first cell, at least one SIB that indicates a list of cells that support one or more NES procedures.

In some examples, the cell reselecting component 845 may be configured as or otherwise support a means for prioritizing or de-prioritizing one or more candidate cells based on the at least one SIB and a capability of the UE to communicate with cells that support one or more NES procedures.

In some examples, the capability determining component 860 may be configured as or otherwise support a means for determining that the second cell supports one or more NES procedures based on the at least one SIB. In some examples, the SIB receiving component 855 may be configured as or otherwise support a means for receiving a first SIB via the second cell that supports NES procedures based on performing the cell reselection procedure, where the first SIB includes a flag to indicate that UEs of a first type are permitted to access the second cell, where the first type is associated with a UE capability to communicate with cells that support one or more NES procedures.

In some examples, to support receiving the system information, the SIB receiving component 855 may be configured as or otherwise support a means for receiving, via the first cell, at least one SIB that indicates one or both of an intra-frequency excluded cell list or an inter-frequency excluded cell list pertaining to UEs that are capable of communicating via cells that support one or more NES procedures.

In some examples, to support receiving the system information, the SIB receiving component 855 may be configured as or otherwise support a means for receiving, via the first cell, at least one SIB that indicates one or both of inter-frequency cell reselection priority information or intra-frequency cell reselection priority information pertaining to UEs that are capable of communicating via cells that support one or more NES procedures.

In some examples, to support receiving the system information, the SIB receiving component 855 may be configured as or otherwise support a means for receiving, via the first cell, at least one SIB that indicates a list of frequencies associated with cells that support one or more NES procedures.

In some examples, the cell reselecting component 845 may be configured as or otherwise support a means for prioritizing or de-prioritizing one or more candidate frequencies based on the at least one SIB and a capability of the UE to communicate with cells that support one or more NES procedures.

In some examples, to support performing the cell reselection procedure, the cell reselecting component 845 may be configured as or otherwise support a means for selecting the second cell based on a capability of the UE to communicate with cells that support one or more NES procedures and the cell reselection information indicating that the second cell supports one or more NES procedures.

In some examples, to support receiving the system information, the system information component 840 may be configured as or otherwise support a means for receiving, via the first cell, UE assistance information that includes a list of candidate cells that support one or more NES procedures.

In some examples, the MIB receiving component 850 may be configured as or otherwise support a means for refraining from processing a MIB associated with a cell that supports one or more NES procedures based on the UE assistance information.

In some examples, the connection establishing component 865 may be configured as or otherwise support a means for establishing a connection with a network entity via the first cell prior to receiving the cell reselection information via the first cell.

In some examples, the connection establishing component 865 may be configured as or otherwise support a means for establishing a connection with a network entity via the second cell after performing the cell reselection procedure in accordance with the cell reselection information.

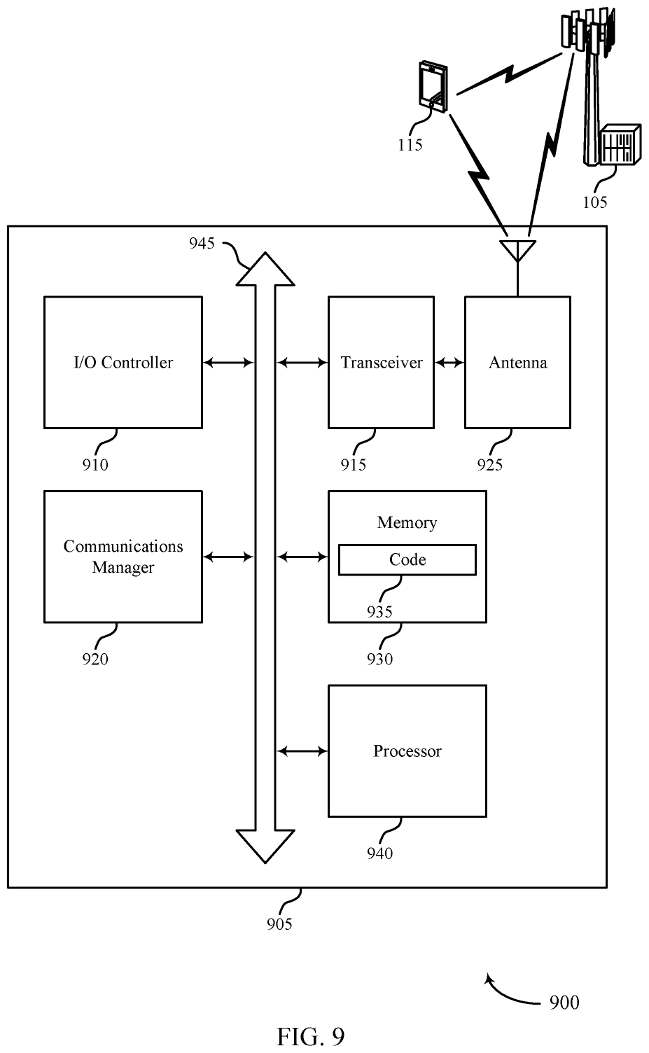

FIG. 9 illustrates a diagram of a system 900 including a device 905 that supports cell barring techniques for devices with NES capabilities in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting cell barring techniques for devices with NES capabilities). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples disclosed herein. For example, the communications manager 920 may be configured as or otherwise support a means for receiving, via a first cell, first system information that indicates a first cell barring parameter associated with the first cell, where the first cell barring parameter is indicative of whether UEs are barred from accessing the first cell. The communications manager 920 may be configured as or otherwise support a means for receiving, via a second cell, second system information that indicates a second cell barring parameter associated with the first cell, where the second cell barring parameter is applicable to UEs of a first type, and where the first type is associated with a UE capability to communicate via cells that support one or more NES procedures. The communications manager 920 may be configured as or otherwise support a means for participating in communications via the first cell based on the UE being of the first type and the second cell barring parameter indicating that UEs of the first type are permitted to access the first cell.

Additionally, or alternatively, the communications manager 920 may support wireless communication at a UE in accordance with examples disclosed herein. For example, the communications manager 920 may be configured as or otherwise support a means for receiving, via a first cell, system information that includes cell reselection information pertaining to cells that support one or more NES procedures. The communications manager 920 may be configured as or otherwise support a means for performing a cell reselection procedure based on the cell reselection information. The communications manager 920 may be configured as or otherwise support a means for participating in one or more communications via a second cell based on the cell reselection procedure.

By including or configuring the communications manager 920 in accordance with examples as described herein, the device 905 may support techniques for reduced power consumption, lower processing overhead, and decreased signaling overhead, among other benefits. For example, if the device 905 determines that a first cell supports NES techniques or is actively employing NES procedures (e.g., based on assistance information provided by the first cell or a second cell), the device 905 may de-prioritize the first cell or refrain from processing other system information messages from the first cell, resulting in greater power savings and reduced processing overhead. The described techniques may also enable NES-capable cells to selectively bar access to legacy and NES-incapable UEs while permitting access to NES-capable UEs, thereby providing greater signaling flexibility and granularity.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of cell barring techniques for devices with NES capabilities as described herein, or the processor 940 and the memory 930 may be otherwise configured to perform or support such operations.

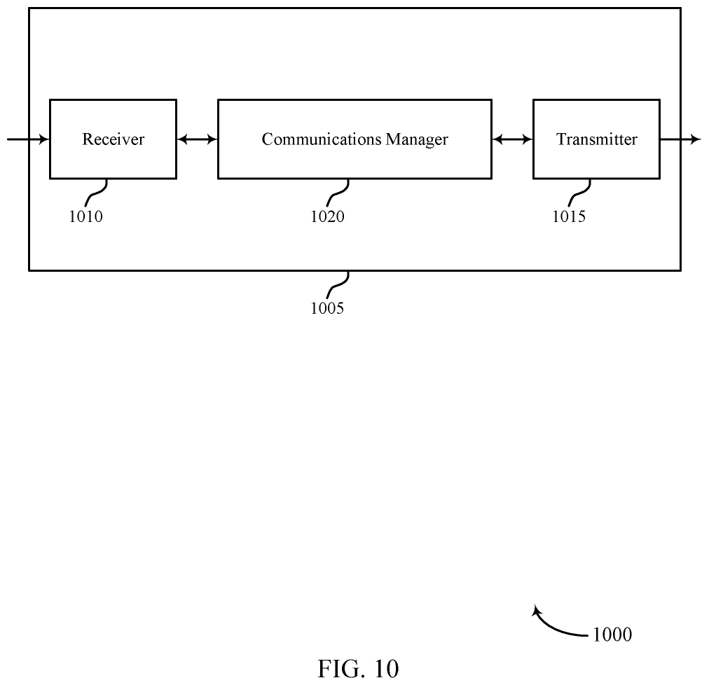

FIG. 10 illustrates a block diagram 1000 of a device 1005 that supports cell barring techniques for devices with NES capabilities in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of cell barring techniques for devices with NES capabilities as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples disclosed herein. For example, the communications manager 1020 may be configured as or otherwise support a means for outputting, via a first cell, first system information that pertaining to a second cell and indicates a first cell barring parameter that is applicable to UEs of a first type and which supersedes a second cell barring parameter provided via a second system information, where the first type is associated with a UE capability to communicate via cells that support one or more NES procedures.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, and reduced signaling overhead, among other benefits.

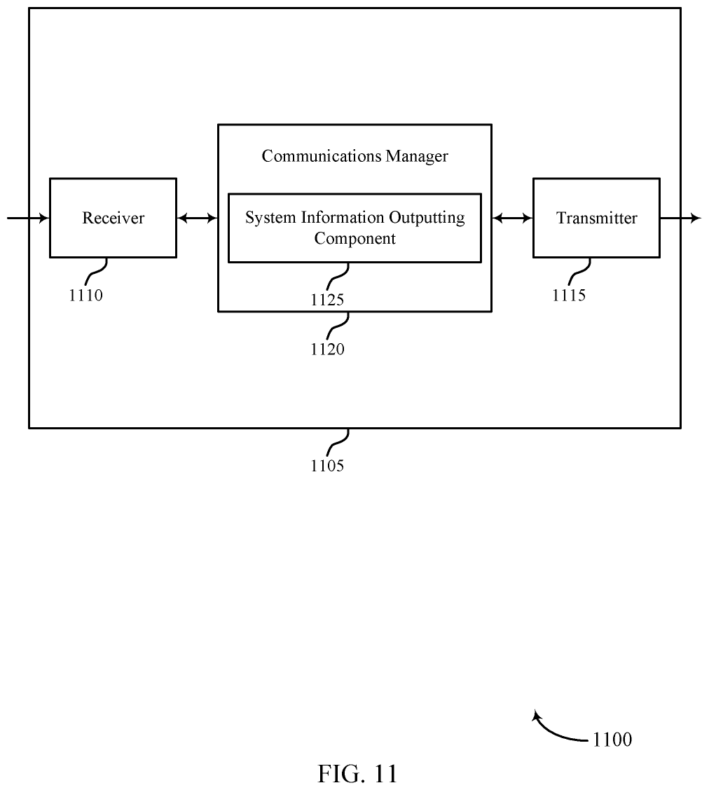

FIG. 11 illustrates a block diagram 1100 of a device 1105 that supports cell barring techniques for devices with NES capabilities in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of cell barring techniques for devices with NES capabilities as described herein. For example, the communications manager 1120 may include a system information outputting component 1125, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples disclosed herein. The system information outputting component 1125 may be configured as or otherwise support a means for outputting, via a first cell, first system information that pertains to a second cell and indicates a first cell barring parameter that is applicable to UEs of a first type and which supersedes a second cell barring parameter provided via a second system information, where the first type is associated with a UE capability to communicate via cells that support one or more NES procedures.

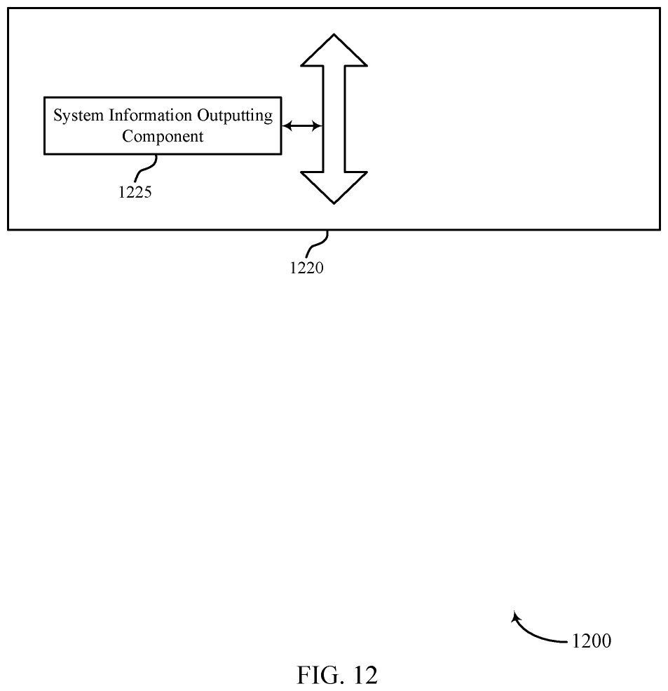

FIG. 12 illustrates a block diagram 1200 of a communications manager 1220 that supports cell barring techniques for devices with NES capabilities in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of cell barring techniques for devices with NES capabilities as described herein. For example, the communications manager 1220 may include a system information outputting component 1225, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples disclosed herein. The system information outputting component 1225 may be configured as or otherwise support a means for outputting, via a first cell, first system information that pertains to a second cell and indicates a first cell barring parameter that is applicable to UEs of a first type and which supersedes a second cell barring parameter provided via a second system information, where the first type is associated with a UE capability to communicate via cells that support one or more NES procedures.

In some examples, the second cell barring parameter supersedes the first cell barring parameter for UEs of the first type. In some examples, the second cell and the first cell are the same. In some examples, the first system information and the second system information are received in a MIB that indicates both the first cell barring parameter and the second cell barring parameter.

In some examples, to support outputting the first system information, the system information outputting component 1225 may be configured as or otherwise support a means for outputting a MIB that indicates the first cell barring parameter.

In some examples, the system information outputting component 1225 may be configured as or otherwise support a means for outputting a SIB that indicates the second cell barring parameter.

In some examples, the second cell barring parameter is a flag in the SIB. In some examples, presence of the flag in the SIB indicates that UEs of the first type are permitted to access the first cell.

In some examples, the second cell barring parameter is a field in the SIB. In some examples, a value of the field is indicative to UEs that are not of the first type that the first cell is not available, and indicative to UEs of the first type that the first cell is available. In some examples, the field in the SIB is one of a cell reservation field or a transmit power field.

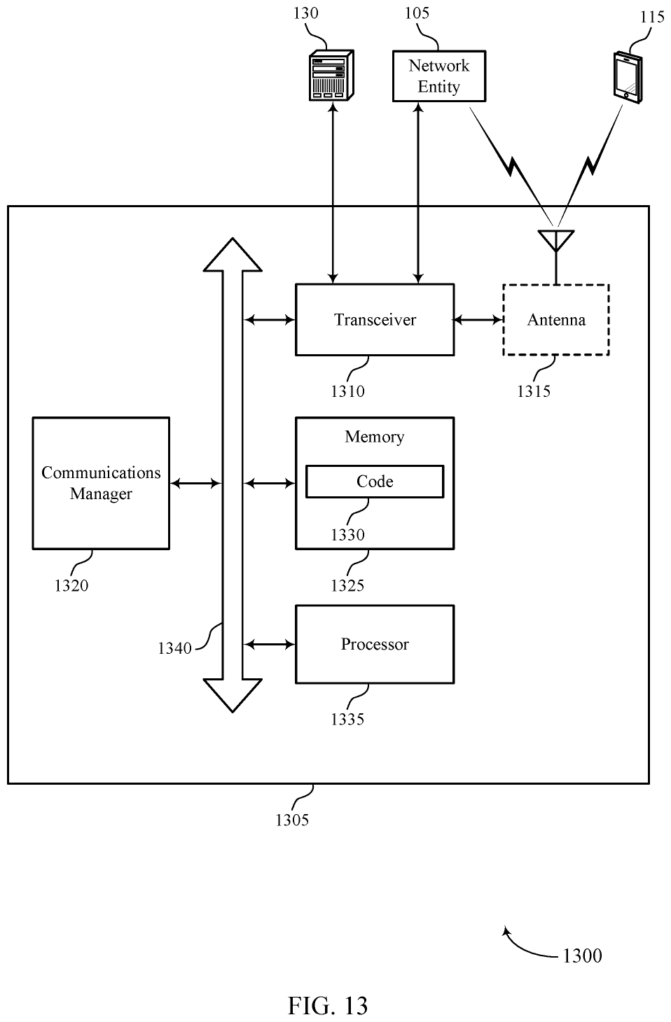

FIG. 13 illustrates a diagram of a system 1300 including a device 1305 that supports cell barring techniques for devices with NES capabilities in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently).

The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof.

In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting cell barring techniques for devices with NES capabilities). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both.

The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples disclosed herein. For example, the communications manager 1320 may be configured as or otherwise support a means for outputting, via a first cell, first system information that pertaining to a second cell and indicates a first cell barring parameter that is applicable to UEs of a first type and which supersedes a second cell barring parameter provided via a second system information, where the first type is associated with a UE capability to communicate via cells that support one or more NES procedures.

By including or configuring the communications manager 1320 in accordance with examples as described herein, the device 1305 may support techniques for reduced power consumption, lower processing overhead, and decreased signaling overhead, among other benefits. For example, if an NES-incapable UE determines that the device 1305 supports NES techniques or is actively employing NES procedures (e.g., based on assistance information provided by the device 1305), the NES-incapable UE may de-prioritize cells associated with the device 1305 or refrain from processing other system information messages from the device 1305, resulting in greater power savings and reduced processing overhead. The described techniques may also enable the device 1305 to selectively bar access to legacy and NES-incapable UEs while permitting access to NES-capable UEs, thereby providing greater signaling flexibility and granularity.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of cell barring techniques for devices with NES capabilities as described herein, or the processor 1335 and the memory 1325 may be otherwise configured to perform or support such operations.

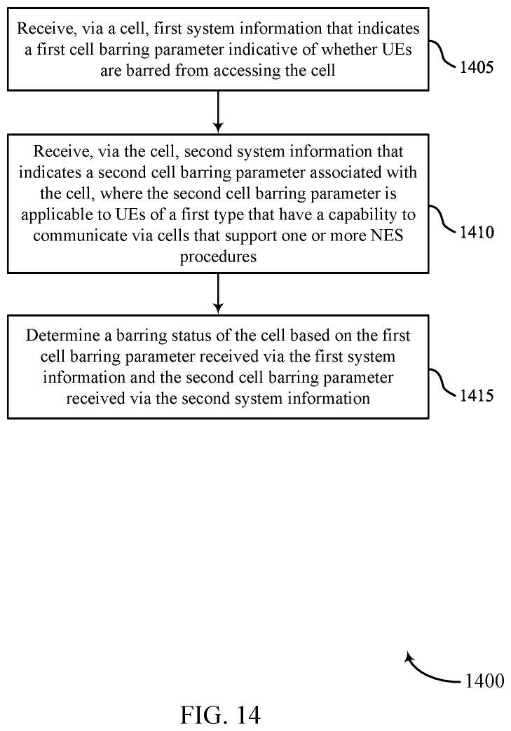

FIG. 14 illustrates a flowchart showing a method 1400 that supports cell barring techniques for devices with NES capabilities in accordance with one or more aspects of the present disclosure. The operations of the method 1400 may be implemented by a UE or components thereof. For example, the operations of the method 1400 may be performed by a UE 115, as described with reference to FIGS. 1 through 9. In some examples, the UE may execute a set of instructions to control the functional elements of the UE to perform the described functions. Additionally, or alternatively, the UE may perform aspects of the described functions using special-purpose hardware.

At 1405, the UE may receive, via a cell, first system information that indicates a first cell barring parameter indicative of whether UEs are barred from accessing the cell. In some examples, the operations of 1405 may be performed by a first cell barring component 825, as described with reference to FIG. 8.

At 1410, the UE may receive, via the cell, second system information that indicates a second cell barring parameter associated with the cell, where the second cell barring parameter is applicable to UEs of a first type that have a capability to communicate via cells that support one or more NES procedures. In some examples, the operations of 1410 may be performed by a second cell barring component 830, as described with reference to FIG. 8.

At 1415, the UE may determine a barring status of the cell based on the first cell barring parameter received via the first system information and the second cell barring parameter received via the second system information. In some examples, the operations of 1415 may be performed by a communication participating component 835, as described with reference to FIG. 8.

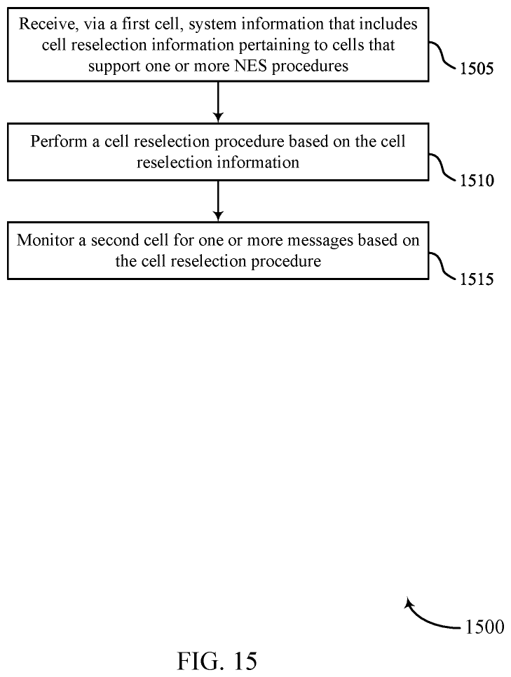

FIG. 15 illustrates a flowchart showing a method 1500 that supports cell barring techniques for devices with NES capabilities in accordance with one or more aspects of the present disclosure. The operations of the method 1500 may be implemented by a UE or components thereof. For example, the operations of the method 1500 may be performed by a UE 115, as described with reference to FIGS. 1 through 9. In some examples, the UE may execute a set of instructions to control the functional elements of the UE to perform the described functions. Additionally, or alternatively, the UE may perform aspects of the described functions using special-purpose hardware.

At 1505, the UE may receive, via a first cell, system information that includes cell reselection information pertaining to cells that support one or more NES procedures. In some examples, the operations of 1505 may be performed by a system information component 840, as described with reference to FIG. 8.

At 1510, the UE may perform a cell reselection procedure based on the cell reselection information. In some examples, the operations of 1510 may be performed by a cell reselecting component 845, as described with reference to FIG. 8.

At 1515, the UE may monitor a second cell for one or more messages based on the cell reselection procedure. In some examples, aspects of the operations of 1515 may be performed by a communication participating component 835, as described with reference to FIG. 8.

The following provides an overview of aspects of the present disclosure:

Aspect 1: A method for wireless communication at a UE, comprising: receiving, via a first cell, first system information that indicates a first cell barring parameter associated with the first cell, wherein the first cell barring parameter is indicative of whether UEs are barred from accessing the first cell; receiving, via a second cell, second system information that indicates a second cell barring parameter associated with the first cell, wherein the second cell barring parameter is applicable to UEs of a first type, and wherein the first type is associated with a UE capability to communicate via cells that support one or more NES procedures; and participating in communications via the first cell based at least in part on the UE being of the first type and the second cell barring parameter indicating that UEs of the first type are permitted to access the first cell.

Aspect 2: The method of aspect 1, wherein the second cell barring parameter supersedes the first cell barring parameter for UEs of the first type.

Aspect 3: The method of any of aspects 1 through 2, wherein the second cell and the first cell are the same, and the first system information and the second system information are received in a MIB that indicates both the first cell barring parameter and the second cell barring parameter.

Aspect 4: The method of any of aspects 1 through 3, wherein the second cell and the first cell are the same, and wherein receiving the first system information comprises: receiving a MIB that indicates the first cell barring parameter; and wherein receiving the second system information comprises: receiving a SIB that indicates the second cell barring parameter.

Aspect 5: The method of aspect 4, wherein the second cell barring parameter is a flag in the SIB, and presence of the flag in the SIB indicates that UEs of the first type are permitted to access the first cell.

Aspect 6: The method of aspect 5, further comprising: evaluating the presence of the flag in the SIB only when the first cell barring parameter in the MIB indicates that UEs are barred from accessing the first cell.

Aspect 7: The method of any of aspects 4 through 6, wherein the second cell barring parameter is a field in the SIB, and a value of the field is indicative to UEs that are not of the first type that the first cell is not available, and indicative to UEs of the first type that the first cell is available.

Aspect 8: The method of aspect 7, wherein the field in the SIB is one of a cell reservation field or a transmit power field.

Aspect 9: The method of any of aspects 1 through 8, wherein the second cell and the first cell are different, and wherein receiving the second system information comprises: receiving a SIB that comprises the second cell barring parameter, wherein the SIB includes cell reselection information pertaining to cells that support one or more NES procedures, the first cell being among the cells identified in the cell reselection information.

Aspect 10: The method of aspect 9, wherein receiving the first system information comprises: receiving, as part of a reselection procedure wherein the first UE transitions from the second cell to the first cell, a MIB that indicates the first cell barring parameter, wherein the first cell barring parameter indicates that UEs are barred from accessing the first cell, but wherein the second cell barring parameter supersedes the first cell barring parameter for UEs of the first type.

Aspect 11: The method of any of aspects 1 through 10, wherein the second cell and the first cell are the same, the method further comprising: receiving third system information, via a third cell that is different from the first cell and the second cell, the third system information being received, prior to reception of the first system information and the second system information, in a SIB that identifies that the first cell supports the one or more NES procedures; and reselecting the first cell based at least in part on the third system information identifying that the first cell supports the one or more NES procedures, wherein reception of the first system information and the second system information is after or a result of the reselection.

Aspect 12: The method of aspect 11, wherein receiving the first system information comprises: receiving a MIB that indicates the first cell barring parameter; and wherein receiving the second system information comprises: receiving an additional SIB that indicates the second cell barring parameter.

Aspect 13: The method of any of aspects 11 through 12, wherein the first system information and the second system information are received in a MIB that indicates both the first cell barring parameter and the second cell barring parameter.

Aspect 14: The method of any of aspects 11 through 13, further comprising: refraining from decoding the first system information based on the third system information.

Aspect 15: A method for wireless communication at a UE, comprising: receiving, via a first cell, system information that comprises cell reselection information pertaining to cells that support one or more NES procedures; performing a cell reselection procedure based at least in part on the cell reselection information; and participating in one or more communications via a second cell based at least in part on the cell reselection procedure.

Aspect 16: The method of aspect 15, wherein receiving the system information comprises: receiving, via the first cell, at least one SIB that indicates a list of cells that support one or more NES procedures.

Aspect 17: The method of any of aspects 15 through 16, further comprising: prioritizing or de-prioritizing one or more candidate cells based at least in part on the at least one SIB and a capability of the UE to communicate with cells that support one or more NES procedures.

Aspect 18: The method of any of aspects 15 through 17, further comprising: determining that the second cell supports one or more NES procedures based at least in part on the at least one SIB; and receiving a first SIB via the second cell that supports NES procedures based at least in part on performing the cell reselection procedure, wherein the first SIB comprises a flag to indicate that UEs of a first type are permitted to access the second cell, wherein the first type is associated with a UE capability to communicate with cells that support one or more NES procedures.

Aspect 19: The method of any of aspects 15 through 18, wherein receiving the system information comprises: receiving, via the first cell, at least one SIB that indicates one or both of an intra-frequency excluded cell list or an inter-frequency excluded cell list pertaining to UEs that are capable of communicating via cells that support one or more NES procedures.

Aspect 20: The method of any of aspects 15 through 19, wherein receiving the system information comprises: receiving, via the first cell, at least one SIB that indicates one or both of inter-cell reselection priority information or intra-cell reselection priority information pertaining to UEs that are capable of communicating via cells that support one or more NES procedures.

Aspect 21: The method of any of aspects 15 through 20, wherein receiving the system information comprises: receiving, via the first cell, at least one SIB that indicates a list of frequencies associated with cells that support one or more NES procedures.

Aspect 22: The method of any of aspects 15 through 21, further comprising: prioritizing or de-prioritizing one or more candidate frequencies based at least in part on the at least one SIB and a capability of the UE to communicate with cells that support one or more NES procedures.

Aspect 23: The method of any of aspects 15 through 22, wherein performing the cell reselection procedure comprises: selecting the second cell based at least in part on a capability of the UE to communicate with cells that support one or more NES procedures and the cell reselection information indicating that the second cell supports one or more NES procedures.

Aspect 24: The method of any of aspects 15 through 23, wherein receiving the system information comprises: receiving, via the first cell, UE assistance information that includes a list of candidate cells that support one or more NES procedures.

Aspect 25: The method of any of aspects 15 through 24, further comprising: refraining from processing a MIB associated with a cell that supports one or more NES procedures based at least in part on the UE assistance information.

Aspect 26: The method of any of aspects 15 through 25, further comprising: establishing a connection with a network entity via the first cell prior to receiving the cell reselection information via the first cell.

Aspect 27: The method of any of aspects 15 through 26, further comprising: establishing a connection with a network entity via the second cell after performing the cell reselection procedure in accordance with the cell reselection information.

Aspect 28: A method for wireless communication at a network entity, comprising: outputting, via a first cell, first system information that pertains to a second cell and indicates a first cell barring parameter that is applicable to UEs of a first type and which supersedes a second cell barring parameter provided via a second system information, wherein the first type is associated with a UE capability to communicate via cells that support one or more NES procedures.

Aspect 29: The method of aspect 28, wherein the second cell barring parameter supersedes the first cell barring parameter for UEs of the first type.

Aspect 30: The method of any of aspects 28 through 29, wherein the second cell and the first cell are the same, and the first system information and the second system information are received in a MIB that indicates both the first cell barring parameter and the second cell barring parameter.

Aspect 31: The method of any of aspects 28 through 30, wherein the second cell and the first cell are the same, and wherein outputting the first system information comprises: outputting a MIB that indicates the first cell barring parameter.

Aspect 32: The method of aspect 31, further comprising: outputting a SIB that indicates the second cell barring parameter.

Aspect 33: The method of aspect 32, wherein the second cell barring parameter is a flag in the SIB, and presence of the flag in the SIB indicates that UEs of the first type are permitted to access the first cell.

Aspect 34: The method of any of aspects 32 through 33, wherein the second cell barring parameter is a field in the SIB, and a value of the field is indicative to UEs that are not of the first type that the first cell is not available, and indicative to UEs of the first type that the first cell is available.

Aspect 35: The method of aspect 34, wherein the field in the SIB is one of a cell reservation field or a transmit power field.

Aspect 36: An apparatus for wireless communication at a UE, comprising: a processor; memory coupled with the processor; and instructions stored in the memory, wherein the instructions are executable by the processor to cause the apparatus to perform a method of any of aspects 1 through 14.

Aspect 37: An apparatus for wireless communication at a UE, comprising at least one means for performing a method of any of aspects 1 through 14.

Aspect 38: A non-transitory computer-readable medium storing code for wireless communication at a UE, the code comprising instructions executable by a processor to perform a method of any of aspects 1 through 14.

Aspect 39: An apparatus for wireless communication at a UE, comprising: a processor; memory coupled with the processor; and instructions stored in the memory, wherein the instructions are executable by the processor to cause the apparatus to perform a method of any of aspects 15 through 27.

Aspect 40: An apparatus for wireless communication at a UE, comprising at least one means for performing a method of any of aspects 15 through 27.

Aspect 41: A non-transitory computer-readable medium storing code for wireless communication at a UE, the code comprising instructions executable by a processor to perform a method of any of aspects 15 through 27.

Aspect 42: An apparatus for wireless communication at a network entity, comprising: a processor; memory coupled with the processor; and instructions stored in the memory, wherein the instructions are executable by the processor to cause the apparatus to perform a method of any of aspects 28 through 35.

Aspect 43: An apparatus for wireless communication at a network entity, comprising at least one means for performing a method of any of aspects 28 through 35.

Aspect 44: A non-transitory computer-readable medium storing code for wireless communication at a network entity, the code comprising instructions executable by a processor to perform a method of any of aspects 28 through 35.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
at least one processor;
at least one memory coupled with the at least one processor; and
instructions stored in the at least one memory and executable by the at least one processor to cause the apparatus to:
receive, via a cell, first system information that indicates a first cell barring parameter indicative of whether UEs are barred from accessing the cell;
receive, via the cell, second system information that indicates a second cell barring parameter associated with the cell, wherein the second cell barring parameter is applicable to UEs of a first type that have a capability to communicate via cells that support one or more network energy saving procedures; and
determine a barring status of the cell based at least in part on the first cell barring parameter received via the first system information and the second cell barring parameter received via the second system information.

2. The apparatus of claim 1, wherein the instructions are further executable by the at least one processor to cause the apparatus to:
participate in communications via the cell based at least in part on the UE being of the first type and the second cell barring parameter indicating that UEs of the first type are permitted to access the cell.

3. The apparatus of claim 1, wherein the second cell barring parameter supersedes the first cell barring parameter for UEs of the first type.

4. The apparatus of claim 1, wherein to receive the first system information, the instructions are executable by the at least one processor to cause the apparatus to:
receive a master information block (MIB) that indicates the first cell barring parameter; and
receive a system information block (SIB) that indicates the second cell barring parameter.

5. The apparatus of claim 4, wherein the second cell barring parameter is a flag in the SIB, and presence of the flag in the SIB indicates that UEs of the first type are permitted to access the cell.

6. The apparatus of claim 5, wherein the instructions are further executable by the at least one processor to cause the apparatus to:
evaluate the presence of the flag in the SIB only when the first cell barring parameter in the MIB indicates that UEs are barred from accessing the cell.

7. The apparatus of claim 4, wherein the second cell barring parameter is a field in the SIB, and a value of the field is indicative to UEs that are not of the first type that the cell is not available, and indicative to UEs of the first type that the cell is available.

8. The apparatus of claim 1, wherein to receive the second system information, the instructions are executable by the at least one processor to cause the apparatus to:
receive a system information block (SIB) that comprises the second cell barring parameter, wherein the SIB includes cell reselection information pertaining to cells that support one or more network energy saving procedures, the cell being among the cells identified in the cell reselection information.

9. The apparatus of claim 8, wherein to receive the first system information, the instructions are executable by the at least one processor to cause the apparatus to:
receive, as part of a reselection procedure wherein the UE transitions from a second cell to the cell, a master information block (MIB) that indicates the first cell barring parameter, wherein the first cell barring parameter indicates that UEs are barred from accessing the cell, but wherein the second cell barring parameter supersedes the first cell barring parameter for UEs of the first type.

10. The apparatus of claim 1, wherein the instructions are further executable by the at least one processor to cause the apparatus to:
receive third system information, via a second cell that is different from the cell, the third system information being received, prior to reception of the first system information and the second system information, in a system information block (SIB) that identifies that the cell supports the one or more network energy saving procedures; and
reselect the cell based at least in part on the third system information identifying that the cell supports the one or more network energy saving procedures, wherein reception of the first system information and the second system information is after or a result of reselecting the cell.

11. The apparatus of claim 10, wherein to receive the first system information, the instructions are executable by the at least one processor to cause the apparatus to:
receive a master information block (MIB) that indicates the first cell barring parameter; and wherein the instructions to receive the second system information are executable by the at least one processor to cause the apparatus to:
receive an additional SIB that indicates the second cell barring parameter.

12. The apparatus of claim 1, wherein the instructions are further executable by the at least one processor to cause the apparatus to:
receive third system information, via a second cell that is different from the cell, the third system information being received, prior to reception of the first system information and the second system information, in a system information block (SIB) that identifies that the cell supports the one or more network energy saving procedures; and
refrain from reselecting the cell or decoding the first system information based at least in part on the third system information.

13. An apparatus for wireless communication at a user equipment (UE), comprising:
at least one processor;
at least one memory coupled with the at least one processor; and
instructions stored in the at least one memory and executable by the at least one processor to cause the apparatus to:
receive, via a first cell, system information that comprises cell reselection information pertaining to cells that support one or more network energy saving procedures;
perform a cell reselection procedure based at least in part on the cell reselection information; and
monitor a second cell for one or more messages based at least in part on the cell reselection procedure.

14. The apparatus of claim 13, wherein to receive the system information, the instructions are executable by the at least one processor to cause the apparatus to:
receive, via the first cell, at least one system information block (SIB) that indicates a list of cells that support one or more network energy saving procedures.

15. The apparatus of claim 14, wherein the instructions are further executable by the at least one processor to cause the apparatus to:
prioritize or de-prioritize one or more candidate cells based at least in part on the at least one SIB and a capability of the UE to communicate with cells that support one or more network energy saving procedures.

16. The apparatus of claim 14, wherein the instructions are further executable by the at least one processor to cause the apparatus to:
determine that the second cell supports one or more network energy saving procedures based at least in part on the at least one SIB; and
receive a first SIB via the second cell that supports network energy saving procedures based at least in part on performing the cell reselection procedure, wherein the first SIB comprises a flag to indicate that UEs of a first type are permitted to access the second cell, wherein the first type is associated with a UE capability to communicate with cells that support one or more network energy saving procedures.

17. The apparatus of claim 13, wherein to receive the system information, the instructions are executable by the at least one processor to cause the apparatus to:
receive, via the first cell, at least one system information block (SIB) that indicates one or both of an intra-frequency excluded cell list or an inter-frequency excluded cell list pertaining to UEs that are capable of communicating via cells that support one or more network energy saving procedures.

18. The apparatus of claim 13, wherein to receive the system information, the instructions are executable by the at least one processor to cause the apparatus to:
receive, via the first cell, at least one system information block (SIB) that indicates one or both of inter-frequency cell reselection priority information or intra-frequency cell reselection priority information pertaining to UEs that are capable of communicating via cells that support one or more network energy saving procedures.

19. The apparatus of claim 13, wherein to receive the system information, the instructions are executable by the at least one processor to cause the apparatus to:
receive, via the first cell, at least one system information block (SIB) that indicates a list of frequencies associated with cells that support one or more network energy saving procedures.

20. The apparatus of claim 19, wherein the instructions are further executable by the at least one processor to cause the apparatus to:
prioritize or de-prioritize one or more candidate frequencies based at least in part on the at least one SIB and a capability of the UE to communicate with cells that support one or more network energy saving procedures.

21. The apparatus of claim 13, wherein to perform the cell reselection procedure, the instructions are executable by the at least one processor to cause the apparatus to:
select the second cell based at least in part on a capability of the UE to communicate with cells that support one or more network energy saving procedures and the cell reselection information indicating that the second cell supports one or more network energy saving procedures.

22. The apparatus of claim 13, wherein to receive the system information, the instructions are executable by the at least one processor to cause the apparatus to:
receive, via the first cell, UE assistance information that includes a list of candidate cells that support one or more network energy saving procedures.

23. The apparatus of claim 22, wherein the instructions are further executable by the at least one processor to cause the apparatus to:
refrain from processing a master information block (MIB) associated with a cell that supports one or more network energy saving procedures based at least in part on the UE assistance information.

24. The apparatus of claim 13, wherein the instructions are further executable by the at least one processor to cause the apparatus to:
establish a connection with a network entity via the first cell prior to receiving the cell reselection information via the first cell.

25. The apparatus of claim 13, wherein the instructions are further executable by the at least one processor to cause the apparatus to:
establish a connection with a network entity via the second cell after performing the cell reselection procedure in accordance with the cell reselection information.

26. A method for wireless communication by a user equipment (UE), comprising:
receiving, via a cell, first system information that indicates a first cell barring parameter indicative of whether UEs are barred from accessing the cell;
receiving, via the cell, second system information that indicates a second cell barring parameter associated with the cell, wherein the second cell barring parameter is applicable to UEs of a first type that have a capability to communicate via cells that support one or more network energy saving procedures; and
determining a barring status of the cell based at least in part on the first cell barring parameter received via the first system information and the second cell barring parameter received via the second system information.

27. The method of claim 26, further comprising:
participating in communications via the cell based at least in part on the UE being of the first type and the second cell barring parameter indicating that UEs of the first type are permitted to access the cell.

28. The method of claim 26, further comprising:
receiving a master information block (MIB) that indicates the first cell barring parameter; and
receiving a system information block (SIB) that indicates the second cell barring parameter.

29. A method for wireless communication by a user equipment (UE), comprising:
receiving, via a first cell, system information that comprises cell reselection information pertaining to cells that support one or more network energy saving procedures;
performing a cell reselection procedure based at least in part on the cell reselection information; and
monitoring a second cell for one or more messages based at least in part on the cell reselection procedure.

30. The method of claim 29, further comprising:
receiving, via the first cell, at least one system information block (SIB) indicating a list of cells that support one or more network energy saving procedures.
